(19) United States
(12) Patent Application Publication
(10) Pub. No.: US 2025/0173748 A1
(43) Pub. Date: May 29, 2025

(54) COLLABORATIVE HUMAN-MACHINE LEARNING SYSTEM

(71) Applicants: BOARD OF TRUSTEES OF THE UNIVERSITY OF ARKANSAS, Little Rock, AR (US); BRIGHAM YOUNG UNIVERSITY, Provo, UT (US)

(72) Inventors: Finnegan McKinley, Fayetteville, AR (US); John Aloysius, Fayetteville (AR); Rebekah Brau, Provo, UT (US)

(73) Assignees: BOARD OF TRUSTEES OF THE UNIVERSITY OF ARKANSAS, Little Rock, AR (US); BRIGHAM YOUNG UNIVERSITY, Provo, UT (US)

(21) Appl. No.: 18/957,286

(22) Filed: Nov. 22, 2024

Related U.S. Application Data
(60) Provisional application No. 63/602,560, filed on Nov. 24, 2023.

(51) Int. Cl. G06Q 30/0202; G06Q 10/0639

(52) U.S. Cl. CPC G06Q 30/0202; G06Q 10/06393

(57) ABSTRACT

The present disclosure relates to systems and methods for collaborative human-machine learning for demand planning. The method includes receiving a forecast for the demand planning from a machine, receiving an indication of a particular event using private information from a user, estimating an effect of the particular event, receiving lagged demand, and adjusting the forecast for the demand planning using the estimated effect of the particular event and the lagged demand.

### CROSS-REFERENCE TO RELATED APPLICATIONS

This application claims priority to U.S. Provisional Patent Application No. 63/602,560, filed on Nov. 24, 2023. The entirety of the aforementioned application is incorporated herein by reference.

### BACKGROUND

The present disclosure relates generally to machine learning, and more particularly, and not by way of limitation, a collaborative human-machine learning system.

### SUMMARY

In an embodiment, the present disclosure pertains to a computer-implemented method for collaborative human-machine learning for demand planning. In some embodiments, the method includes receiving a forecast for the demand planning from a machine, receiving an indication of a particular event using private information from a user, estimating an effect of the particular event, receiving lagged demand, and adjusting the forecast for the demand planning using the estimated effect of the particular event and the lagged demand.

In an additional embodiment, the present disclosure pertains to a computer program product for collaborative human-machine learning for demand planning. In some embodiments, the computer program product includes one or more non-transitory computer readable storage mediums having program code embodied therewith. In some embodiments, the program code includes programming instructions for receiving a forecast for the demand planning from a machine, receiving an indication of a particular event using private information from a user, estimating an effect of the particular event, receiving lagged demand, and adjusting the forecast for the demand planning using the estimated effect of the particular event and the lagged demand.

In a further embodiment, the present disclosure pertains to a system having a memory for storing a computer program for collaborative human-machine learning for demand planning and a processor connected to the memory. In some embodiments, the processor is configured to execute program instructions of the computer program including receiving a forecast for the demand planning from a machine, receiving an indication of a particular event using private information from a user, estimating an effect of the particular event, receiving lagged demand, and adjusting the forecast for the demand planning using the estimated effect of the particular event and the lagged demand.

### BRIEF DESCRIPTION OF THE DRAWINGS

A better understanding of the present invention can be obtained when the following detailed description is considered in conjunction with the following drawings, in which:

FIG. 1 illustrates an example of a communication system for implementing various principles of a demand planning system according to certain embodiments.

FIG. 2 illustrates an example of hardware configuration for a demand planning system according to certain embodiments.

FIG. 3 illustrates an example method for improving accuracy for demand planning using collaborative human-machine learning according to certain embodiments.

FIG. 4 illustrates example methods of integration by adjustment reason according to certain embodiments.

FIG. 5 illustrates an example data structure according to certain embodiments.

FIG. 6 illustrates an example process of integration according to certain embodiments.

FIG. 7 illustrates an example framework as it relates to the value creation of analytics according to certain embodiments.

FIG. 8 illustrates forecasting accuracy comparisons according to certain embodiments.

### DETAILED DESCRIPTION

It is to be understood that both the foregoing general description and the following detailed description are illustrative and explanatory, and are not restrictive of the subject matter, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that include more than one unit unless specifically stated otherwise.

The section headings used herein are for organizational purposes and are not to be construed as limiting the subject matter described. All documents, or portions of documents cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

Machine learning (ML) is a field of study in artificial intelligence concerned with the development and study of statistical algorithms that can effectively generalize and thus perform tasks without explicit instructions. Machine learning approaches have been applied to large language models, computer vision, speech recognition, email filtering, agriculture and medicine, where it is too costly to develop algorithms to perform the needed tasks.

Machine learning has also been applied to supply chain management. For example, firms are looking to implement machine learning tools for their demand planning processes in the supply chain. A supply chain is a complex logistics system that consists of facilities that convert raw materials into finished products and distribute them to end consumers or end customers. Meanwhile, supply chain management deals with the flow of goods within the supply chain in the most efficient manner.

Unfortunately, despite the development of very sophisticated machine learning algorithms, the accuracy of such algorithms, such as demand planning in the retail industry, can be improved. For example, human managers have the ability to sense change and to detect anomalies that the algorithm is not able to perceive and incorporate. As a result, human managers may override the output of the algorithm in an attempt to improve demand planning results (i.e., to improve the forecast accuracy). Studies, however, suggest that human overrides are subject to biases in judgement, which also results in inaccuracies.

As a result, even with the assistance of human overrides, the forecasting of such machine learning algorithms, such as demand planning in the retail industry, can still be improved.

The embodiments of the present disclosure provide a method for improving the forecasting of machine learning algorithms, such as demand planning in the retail industry, by integrating algorithm-based machine learning systems with human judgement. In particular, the algorithm systematically evaluates human judgment capabilities and algorithmic processing simultaneously. Though there is no a priori intention to assign primacy to the human or the machine, the human-algorithm integration of the present disclosure facilitates an agency reversal. Rather than human learning from the machine learning algorithm, the machine learning algorithm learns from human input and systematically integrates machine and human input. Furthermore, such collaborative human-machine learning (CHML) can improve human judgment, thereby improving the overall process performance despite, well-documented frailties in human judgment-namely, judgment bias and sequential effects in judgment. These and other features will be discussed in further detail herein.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill in the relevant art.

### Demand Planning System

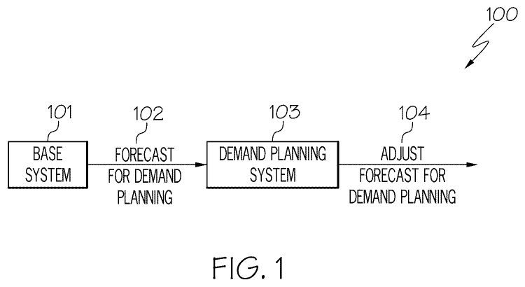

FIG. 1 illustrates an embodiment of the present disclosure of a communication system 100 for practicing the principles of the present disclosure. Communication system 100 includes a base system 101, such as a statistical model, a machine learning model or an algorithm, that uses public information to produce a forecast for demand planning 102. “Forecast,” as used herein, refers to predicting or estimating. “Demand planning,” as used herein, refers to a cross-functional process that helps businesses meet customer demand for products while minimizing excess inventory and avoiding supply chain disruptions.

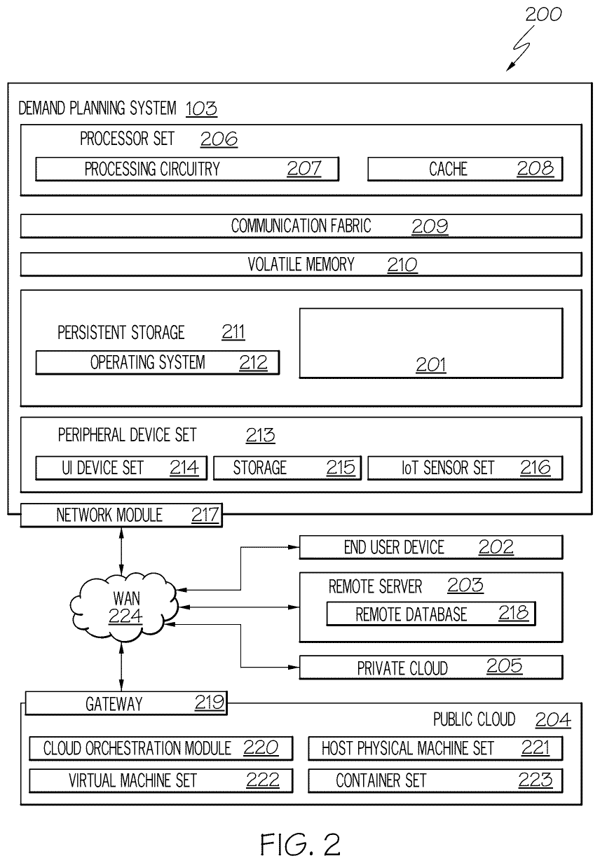

As shown in FIG. 1, such a forecast for demand planning 102 is input into a demand planning system 103, which utilizes collaborative human-machine learning for adjusting the forecast for demand planning (see element 104), where such an adjustment improves the accuracy for such a forecast as discussed herein. A description of the hardware configuration of demand planning system 103 is provided below in connection with FIG. 2.

Referring now to FIG. 2, in conjunction with FIG. 1, FIG. 2 illustrates an embodiment of the present disclosure of the hardware configuration of demand planning system 103 which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 200 contains an example of an environment for the execution of at least some of the computer code (stored in block 201) involved in performing the disclosed methods, such as improving the accuracy for demand planning by using collaborative human-machine learning. In addition to block 201, computing environment 200 includes, for example, demand planning system 103, wide area network (WAN) 224, end user device (EUD) 202, remote server 203, public cloud 204, and private cloud 205. In this embodiment, demand planning system 103 includes processor set 206 (including processing circuitry 207 and cache 208), communication fabric 209, volatile memory 210, persistent storage 211 (including operating system 212 and block 201, as identified above), peripheral device set 213 (including user interface (UI) device set 214, storage 215, and Internet of Things (IoT) sensor set 216), and network module 217. Remote server 203 includes remote database 218. Public cloud 204 includes gateway 219, cloud orchestration module 220, host physical machine set 221, virtual machine set 222, and container set 223.

Demand planning system 103 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 218. As is well understood in the art of computer technology, and depending upon the technology, performance of a computer-implemented method may be distributed among multiple computers and/or between multiple locations. On the other hand, in this presentation of computing environment 200, detailed discussion is focused on a single computer, specifically demand planning system 103, to keep the presentation as simple as possible. Demand planning system 103 may be located in a cloud, even though it is not shown in a cloud in FIG. 2. On the other hand, demand planning system 103 is not required to be in a cloud except to any extent as may be affirmatively indicated.

Processor set 206 includes one, or more, computer processors of any type now known or to be developed in the future. Processing circuitry 207 may be distributed over multiple packages, for example, multiple, coordinated integrated circuit chips. Processing circuitry 207 may implement multiple processor threads and/or multiple processor cores. Cache 208 is memory that is located in the processor chip package(s) and is typically used for data or code that should be available for rapid access by the threads or cores running on processor set 206. Cache memories are typically organized into multiple levels depending upon relative proximity to the processing circuitry. Alternatively, some, or all, of the cache for the processor set may be located “off chip.” In some computing environments, processor set 206 may be designed for working with qubits and performing quantum computing.

Computer readable program instructions are typically loaded onto demand planning system 103 to cause a series of operational steps to be performed by processor set 206 of demand planning system 103 and thereby effect a computer-implemented method, such that the instructions thus executed will instantiate the methods specified in flowcharts and/or narrative descriptions of computer-implemented methods included in this document (collectively referred to as “the disclosed methods”). These computer readable program instructions are stored in various types of computer readable storage media, such as cache 208 and the other storage media discussed below. The program instructions, and associated data, are accessed by processor set 206 to control and direct performance of the disclosed methods. In computing environment 200, at least some of the instructions for performing the disclosed methods may be stored in block 201 in persistent storage 211.

Communication fabric 209 is the signal conduction paths that allow the various components of demand planning system 103 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 210 is any type of volatile memory now known or to be developed in the future. Examples include dynamic type random access memory (RAM) or static type RAM. Typically, the volatile memory is characterized by random access, but this is not required unless affirmatively indicated. In demand planning system 103, the volatile memory 210 is located in a single package and is internal to demand planning system 103, but, alternatively or additionally, the volatile memory may be distributed over multiple packages and/or located externally with respect to demand planning system 103.

Persistent Storage 211 is any form of non-volatile storage for computers that is now known or to be developed in the future. The non-volatility of this storage means that the stored data is maintained regardless of whether power is being supplied to demand planning system 103 and/or directly to persistent storage 211. Persistent storage 211 may be a read only memory (ROM), but typically at least a portion of the persistent storage allows writing of data, deletion of data and re-writing of data. Some familiar forms of persistent storage include magnetic disks and solid-state storage devices. Operating system 212 may take several forms, such as various known proprietary operating systems or open-source Portable Operating System Interface type operating systems that employ a kernel. The code included in block 201 typically includes at least some of the computer code involved in performing the disclosed methods.

Peripheral device set 213 includes the set of peripheral devices of demand planning system 103. Data communication connections between the peripheral devices and the other components of demand planning system 103 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 214 may include components such as a display screen, speaker, microphone, wearable devices (such as goggles and smart watches), keyboard, mouse, printer, touchpad, game controllers, and haptic devices. Storage 215 is external storage, such as an external hard drive, or insertable storage, such as an SD card. Storage 215 may be persistent and/or volatile. In some embodiments, storage 215 may take the form of a quantum computing storage device for storing data in the form of qubits. In embodiments where demand planning system 103 is required to have a large amount of storage (for example, where demand planning system 103 locally stores and manages a large database) then this storage may be provided by peripheral storage devices designed for storing very large amounts of data, such as a storage area network (SAN) that is shared by multiple, geographically distributed computers. IoT sensor set 216 is made up of sensors that can be used in Internet of Things applications. For example, one sensor may be a thermometer and another sensor may be a motion detector.

Network module 217 is the collection of computer software, hardware, and firmware that allows demand planning system 103 to communicate with other computers through WAN 224. Network module 217 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 217 are performed on the same physical hardware device. In other embodiments (for example, embodiments that utilize software-defined networking (SDN)), the control functions and the forwarding functions of network module 217 are performed on physically separate devices, such that the control functions manage several different network hardware devices. Computer readable program instructions for performing the disclosed methods can typically be downloaded to demand planning system 103 from an external computer or external storage device through a network adapter card or network interface included in network module 217.

WAN 224 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 202 is any computer system that is used and controlled by an end user (for example, a customer of an enterprise that operates demand planning system 103) and may take any of the forms discussed above in connection with demand planning system 103. EUD 202 typically receives helpful and useful data from the operations of demand planning system 103. For example, in a hypothetical case where demand planning system 103 is designed to provide a recommendation to an end user, this recommendation would typically be communicated from network module 217 of demand planning system 103 through WAN 224 to EUD 202. In this way, EUD 202 can display, or otherwise present, the recommendation to an end user. In some embodiments, EUD 202 may be a client device, such as thin client, heavy client, mainframe computer, desktop computer and so on.

Remote server 203 is any computer system that serves at least some data and/or functionality to demand planning system 103. Remote server 203 may be controlled and used by the same entity that operates demand planning system 103. Remote server 203 represents the machine(s) that collect and store helpful and useful data for use by other computers, such as demand planning system 103. For example, in a hypothetical case where demand planning system 103 is designed and programmed to provide a recommendation based on historical data, then this historical data may be provided to demand planning system 103 from remote database 218 of remote server 203.

Public cloud 204 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 204 is performed by the computer hardware and/or software of cloud orchestration module 220. The computing resources provided by public cloud 204 are typically implemented by virtual computing environments that run on various computers making up the computers of host physical machine set 221, which is the universe of physical computers in and/or available to public cloud 204. The virtual computing environments (VCEs) typically take the form of virtual machines from virtual machine set 222 and/or containers from container set 223. It is understood that these VCEs may be stored as images and may be transferred among and between the various physical machine hosts, either as images or after instantiation of the VCE. Cloud orchestration module 220 manages the transfer and storage of images, deploys new instantiations of VCEs and manages active instantiations of VCE deployments. Gateway 219 is the collection of computer software, hardware, and firmware that allows public cloud 204 to communicate through WAN 224.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 205 is similar to public cloud 204, except that the computing resources are only available for use by a single enterprise. While private cloud 205 is depicted as being in communication with WAN 224 in other embodiments, a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 204 and private cloud 205 are both part of a larger hybrid cloud.

Block 201 further includes the software components configured to improve the accuracy for demand planning by using collaborative human-machine learning. In one embodiment, such components may be implemented in hardware. The functions discussed herein performed by such components are not generic computer functions. As a result, demand planning system 103 is a particular machine that is the result of implementing specific, non-generic computer functions.

In some embodiments, the functionality of such software components of demand planning system 103, including the functionality for improving the accuracy for demand planning by using collaborative human-machine learning, may be embodied in an application specific integrated circuit.

For example, the present disclosure pertains to, in certain embodiments, a computer program product for collaborative human-machine learning for demand planning. In some embodiments, the computer program product includes one or more non-transitory computer readable storage mediums having program code embodied therewith. In some embodiments, the program code includes programming instructions for methods for collaborative human-machine learning for demand planning (as discussed in further detail below).

In a further example, the present disclosure, in some embodiments, pertains to a system having a memory for storing a computer program for collaborative human-machine learning for demand planning and a processor connected to the memory. In some embodiments, the processor is configured to execute program instructions of the computer program for collaborative human-machine learning for demand planning (as discussed in further detail below).

### Methods for Improving the Forecasting of Machine Learning Algorithms

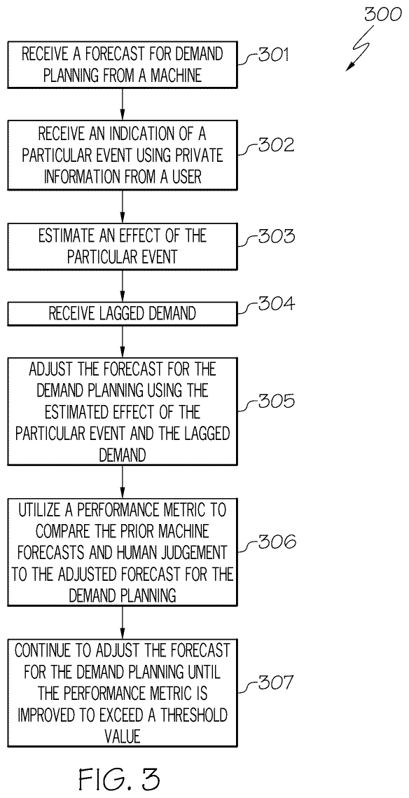

The embodiments of the present disclosure provide a method for improving the forecasting of machine learning algorithms, such as demand planning in the retail industry, by integrating algorithm-based machine learning systems with human judgement as discussed below in connection with FIG. 3. FIG. 3 is a flowchart of a method 300 for improving the accuracy for demand planning by using collaborative human-machine learning in accordance with an embodiment of the present disclosure.

Referring to FIG. 3, in conjunction with FIG. 1 and FIG. 2, in step 301, demand planning system 103 receives a forecast for demand planning from a machine (e.g., base system 101). In one embodiment, such a machine corresponds to a statistical model, a machine learning model or an algorithm that uses public information to produce the forecast for the demand planning.

In one embodiment, demand planning system 103 solves a forecasting learning problem that consists of improving a performance metric (i.e., forecast accuracy) and predicting demand through training experience. In one embodiment, such a forecasting learning problem is solved by demand planning system 103 by receiving a machine forecast (forecast for demand planning from a machine, such as base system 101), which refers to the output produced by the base system that processes available public information.

In step 302, demand planning system 103 receives an indication of a particular event using private information from a user, such as a user of demand planning system 103. In one embodiment, such an indication of the particular event is provided to demand planning system 103 from a user via the graphical user interface of demand planning system 103 or through any other input means (e.g., UI device set 214).

As previously discussed, humans are subject to bias. As a result, based on research, the most accurate method of including private information through human judgment in the forecasting process is by human judgment to identify a particular event using private information. Private information, as used herein, refers to information with predictive value that an algorithm (collaborative human-machine learning algorithm of the present disclosure) does not take into account.

In step 303, the collaborative human-machine learning algorithm of demand planning system 103 estimates an effect of the particular event.

Using an algorithm (collaborative human-machine learning algorithm of the present disclosure) that estimates the event's effect (human-guided learning) will be more accurate than using human judgment to estimate the effect of the special event. The reason is that an algorithm (collaborative human-machine learning algorithm of the present disclosure) that weighs the effect based on the prior history of such estimates (integrated judgment learning) will correct for potential human bias.

In step 304, demand planning system 103 receives lagged demand. Lagged demand, as used herein, refers to demand that has occurred in the past. In one embodiment, demand planning system 103 additionally receives lagged judgements. Lagged judgements, as used herein, refer to human judgements that have been made in the past.

Since human judgment uses private information to explain noise previously unexplained in machine forecasts by base system 101, it may be desirable to incorporate judgment into the process. However, including human judgment may result in a potential violation of independent and identically distributed (IID) data. That is, the introduction of human judgment may reduce noise by explaining previously unlabeled noise, but it also may introduce noise, as human judgment is prone to many biases. Additionally, the private information used to inform judgment originates from many sources, all possibly interdependent with differing distributions. The violation of IID assumptions interferes with accuracy, reliability, and generalization of predictions. By including lagged demand and/or lagged judgements, the additional noise and interdependent sources of private information are accounted for, ensuring predictions are as accurate, reliable, and generalizable as possible.

In step 305, the collaborative human-machine learning algorithm of demand planning system 103 adjusts the forecast for the demand planning using the estimated effect of the particular event and the lagged demand. In one embodiment, the collaborative human-machine learning algorithm of demand planning system 103 adjusts the forecast for the demand planning using the estimated effect of the particular event, the lagged demand, and the lagged judgements.

In step 306, the collaborative human-machine learning algorithm of demand planning system 103 utilizes a performance metric to compare the prior machine forecasts and human judgement to the adjusted forecast for the demand planning.

In step 307, the collaborative human-machine learning algorithm of demand planning system 103 continues to adjust the forecast for the demand planning until the performance metric is improved to exceed a threshold value.

In view of the aforementioned, the present disclosure, in various embodiments, pertains to a computer-implemented method for collaborative human-machine learning for demand planning. In some embodiments, the method includes receiving a forecast for the demand planning from a machine, receiving an indication of a particular event using private information from a user, estimating an effect of the particular event, receiving lagged demand, and adjusting the forecast for the demand planning using the estimated effect of the particular event and the lagged demand.

In some embodiments, the machine includes at least one of a statistical model, a machine learning model, or an algorithm that uses public information to produce the forecast for the demand planning. In some embodiments, the estimate of the effect of the particular event is based, at least in part, on weighing the particular event's effect based on a prior history of estimates of the particular event's effect. In some embodiments, the method includes utilizing a performance metric to compare prior machine forecasts and human judgement to the adjusted forecast for the demand planning. In some embodiments, the method includes continuing to adjust the forecast for the demand planning until the performance metric is improved to exceed a threshold value. In some embodiments, the method includes receiving lagged judgements and adjusting the forecast for the demand planning using at least one of the estimated effect of the particular event, the lagged demand, and the lagged judgements. In some embodiments, the private information corresponds to information with predictive value that an algorithm does not take into account.

### Applications and Advantages

As discussed above, demand planning system 103 solves a forecasting learning problem that consists of improving a performance metric (i.e., forecast accuracy) and predicting demand through training experience. In one embodiment, the performance metric measures whether learning has occurred. In one embodiment, the performance metric improves the predictive ability of the collaborative human-machine learning algorithm of demand planning system 103 as it incorporates quantified past and present learning into the training experience and improves training efficiency.

First, by quantifying learning using a performance metric and then including the metric in the collaborative human-machine learning algorithm, not only is past learning incorporated for future predictions, but it also facilitates a continuous cycle of learning, which can account for changes in learning over time. Second, similar to what has been shown with humans, learning from previous algorithms can help improve efficiency during training. As such, performance metrics comparing prior machine forecasts and human judgment to demand in the collaborative human-machine learning algorithm enhances learning efficiency.

Furthermore, the inclusion of a performance metric improves quality management, such as through continuous improvement and learning cycles. For instance, continuous improvement of a process is achieved through evaluating performance and applying learning from previous cycles to the next period. Similarly, in human-machine learning for forecasting, continuous improvement is attained through evaluating performance (i.e., performance metric) and applying past learning to future predictions (i.e., including the performance metric in the collaborative human-machine learning algorithm).

In one embodiment, method 300 was implemented using a data set containing ten product categories. The dataset contains sales, machine forecasts, and adjustments at the stock keeping unit (SKU)-store-week level. The dataset included 1,932,205 forecasts with 577,079 adjustments across 1,590 stores and 121 SKUs. Categories span consumables (supplements, foot care, baby) and groceries (spices).

In one embodiment, the collaborative human-machine learning algorithm of demand planning system 103 was trained, such as on the first 20 weeks of a particular SKU-store observation set, predicting the demand for such items for the following week, and then updating the algorithm for each subsequent week.

In one embodiment, the prediction of the collaborative human-machine learning algorithm of demand planning system 103 is computed for each SKU-store i week t using machine forecast (MF_{i, t}), human judgment (HumanJudgment_{i, t}), sequential effects in judgment (HumanJudgment_{i, t-1}) and sequential effects in demand (Sales_{i, t-1}) resulting in the collaborative human-machine learning algorithm with no performance metric, or CHMLNP (Equation 1).

$$C H M L {1}_{i , t ,} = {β}_{0 , iT} + {β}_{1} {MF}_{i , t} + {β}_{2} {HumanJudgment}_{i , t} + {β}_{3} {HumanJudgment}_{i , t - 1} + {β}_{4} {Sales}_{i , t - 1} \qquad ( 1 )$$

$$where {HumanJudgment}_{i , t} = \{ \begin{matrix}0 if {ADJ}_{i , f} = 0 \\ 1 if {ADJ}_{i , f} \neq 0\end{matrix}$$

The performance metric (Perfomance_{i, t}) is then computed as the deviation between CHMLNP and sales following Equation 2.

$${Performance}_{i , t} = C H M L N {P}_{i , t} - {Sales}_{i , t - 1} \qquad ( 2 )$$

Lastly, the collaborative human-machine learning algorithm is generated for each SKU-store i week t using machine forecast (MF_{i, t}), human judgment (HumanJudgment_{i, t}), sequential effects in judgment (HumanJudgment_{i, t-1}) sequential effects in demand (Sales_{i, t-1}), and the performance metric (Perfomance_{i, t}) as illustrated in Equation 3.

$$C H M {L}_{i , t ,} = {β}_{0 , iT} + {β}_{1} M {F}_{i , t} + {β}_{2} {HumanJudgment}_{i , t} + {β}_{3} {HumanJudgment}_{i , t - 1} + {β}_{4} {Sales}_{i , i - 1} + {β}_{5} {Performance}_{i , t} \qquad ( 3 )$$

Based on the analysis of the output of the collaborative human-machine learning algorithm, it was discovered that each element, Machine Forecast, Human Judgment, Sequential Effects in Human Judgment, Sequential Effects in Demand, and the Performance Metric, has predictive power.

For example, a fixed effects regression analysis with standard errors clustered at the SKU-store-week level was conducted. Table 1 reports the results of this regression.

TABLE 1
Predictive Power of the Elements

| | Coefficient | SE | t | p-value |
|---|---|---|---|---|
| Machine Forecast | 0.412 | 0.028 | 14.700 | 0.000*** |
| Human Judgment | 1.436 | 0.058 | 24.740 | 0.000*** |
| Sequential Judgment | −0.296 | 0.070 | −4.260 | 0.000*** |
| Sequential Demand | 0.425 | 0.020 | 21.090 | 0.000*** |
| Performance Metric | −0.032 | 0.017 | −1.890 | 0.059* |

N = 1,311,005;
Groups = 31,060;
*p < 0.1,
** p < 0.05,
***p < 0.01

Overall, the elements are relatively significant predictors of demand. Machine Forecast, Human Judgment, Sequential Judgment, and Sequential Demand are all significant at the p<0.01 level. At this aggregate level, the Performance Metric is marginally significant at the p<0.1 level. In this manner, the accuracy for demand planning is improved by using collaborative human-machine learning.

### Additional Embodiments

Reference will now be made to more specific embodiments of the present disclosure and experimental results that provide support for such embodiments. However, Applicants note that the disclosure below is for illustrative purposes only and is not intended to limit the scope of the claimed subject matter in any way.

### Example 1. Demand Planning for the Digital Supply Chain: How to Integrate Human Judgment and Predictive Analytics

Applicants' research examines how to integrate human judgment and statistical algorithms for demand planning in an increasingly data-driven and automated environment. Applicants use a laboratory experiment combined with a field study to compare existing integration methods with a novel approach: Human-Guided Learning. This new method allows the algorithm to use human judgment to train a model using an iterative linear weighting of human judgment and model predictions. Human-Guided Learning is more accurate vis-à-vis the established integration methods of Judgmental Adjustment, Quantitative Correction of Human Judgment, Forecast Combination, and Judgment as a Model Input. Human-Guided Learning performs similarly to Integrative Judgment Learning, but under certain circumstances, Human-Guided Learning can be more accurate. Applicants' studies demonstrate that the benefit of human judgment for demand planning processes depends on the integration method.

### Example 1.1. Introduction

Digitization has changed supply chain management. As supply chain functions become increasingly data-driven and automated, what is the role of supply chain professionals going forward? One domain where human judgment continues to be important is demand planning. The digitization of demand planning processes accelerates supply chain decision-making; effectively leveraging human judgment in increasingly automated forecasting processes is thus vital. Retail supply chains play a particular role in this context, not only because of the scale of their forecasting task, with possibly many thousands of SKUs and store locations, different channels, time horizons, and different hierarchical levels, but also because of the rapidly changing market environment and the sophistication of technological developments in this area.

Given the scale of modern demand planning for many firms, their processes cannot be slow and manual. Still, they must also pay attention to the value their employees can contribute by understanding market shifts. According to a recent Association of Supply Chain Management research report, 83.6% of respondents (representing over 240 firms) indicated they rely on some form of integration of human judgment and analytical models for their forecasts. Integration is the process of using quantitative methods together with human judgment. Specifically, Applicants refer to integration as the process of weighing information and using such weights to synthesize different sources of information into a forecast.

Given this prevalence of hybrid man-machine forecasting, should forecasters adjust the output of an algorithm, or should their information become an input to the algorithm? Applicants examine how firms should integrate judgmental and model-based forecasts to improve their forecasting performance.

To understand effective integration, Applicants invoke Moravec's Paradox. This paradox posits that algorithms can more easily replace higher-level reasoning tasks (e.g., playing chess, intelligence tests) than lower-level tasks (e.g., paying attention to interesting things, face and voice recognition, judging motivation). This insight can explain the relative strengths of human judgment and models in demand planning. It has been summarized that: “When models (humans) are weak, humans (models) are strong”. The human mind thrives in the face of special events where flexibility, subjective evaluation, and additional information are necessary to interpret the event. Statistical methods perform better relative to judgment when variability is low; they excel in stable environments where trend detection, the optimal weighting of evidence, and systematic integration allow for accurate forecasts.

In 1997, IBM's Deep Blue supercomputer beat the world's best human chess player, Garry Kasparov, for the first time. This event was significant in artificial intelligence. Kasparov, in a reflective book, proposed Kasparov's Law, which posits that human judgment and models integrated via the proper process result in better decisions than a strong model alone:
A clever process beat superior knowledge and superior technology. It didn't render knowledge and technology obsolete, of course, but it illustrated the power of efficiency and coordination to dramatically improve results. I represented my conclusion like this: weak human+machine+better process was superior to a strong computer alone and, more remarkably, superior to a strong human+machine+inferior process (Kasparov).

Kasparov's quote here emphasizes the importance of the process. In the context of demand planning, the integration method determines the process. The established integration methods in demand planning roughly fall into five categories: Judgmental Adjustment, Quantitative Correction, Forecast Combination, Input to Model-Building, and Integrative Judgment Learning.

The most common method of integration used in practice is Judgmental Adjustment. Human forecasters receive output from a model and then adjust it according to their intuition or other private information. Another method of integration is Quantitative Correction. This method separates bias in the judgmental forecast into distinct components and thus observes systematic weakness in the forecasters' behavior. A third method of integration—Forecast Combination—is highlighted by previous researchers. In this method, an equal-weighted average of human intuition and statistical modeling substantially improves predictive accuracy. The integration of judgment and models occurs through mechanical computation of the average of the two forecasts. Research into the accuracy of this method has demonstrated mixed results, and practitioners rarely use it. The fourth method utilizes automated quantitative methods such as extrapolation, quantitative analogies, rule-based forecasting, econometric methods, and index methods to integrate human judgment as an input to the model. With judgment as an input to the model, in Input to Model-Building, humans define parameters for the model, and the model then produces the forecast. According to existing literature, Input to Model-Building should be the most accurate form of integration; however, few researchers have empirically tested this claim. Lastly, Integrative Judgment Learning utilizes human adjustments as a predictive variable in the forecasting model. The idea underlying Integrative Judgment Learning is that while humans have insights into special events via private information, the model is better equipped to weigh their judgment and account for biases.

Applicants' research has two objectives: (1) Empirically conduct a comprehensive comparison of integration methods in a setting with demand shocks that human forecasters have information on, and (2) Develop an algorithm for the integration of human judgment with analytical models using a supervised learning approach to simultaneously take advantage of the strengths of human judgment and the strengths of models. Specifically, Applicants propose and test a novel method of integrating model forecasts and human judgment in Applicants' research.

This method extends the idea of Integrative Judgment Learning. When Applicants use human judgment to identify a special event, Applicants can apply a linear regression model using the model forecast and indicator variables about previous occurrences of the special event to estimate a systematic effect due to that event. Thus, when a human manager identifies a special event, the system can incorporate the estimated impact to arrive at a more accurate forecast. Applicants term this technique Human-Guided Learning.

To accomplish these objectives, Applicants first designed a controlled laboratory experiment. Study 1 uses a simple demand planning environment and compares the integration methods by their forecast accuracy. Applicants then conduct a field study to examine the effectiveness of several integration methods with regular forecasters in their everyday work setting. The laboratory experiment and the field study have complementary purposes. In Applicants' behavioral laboratory experiment, Applicants “study human behavior in situations that, in simplified and pure forms, mimic those encountered in markets and other forms of economic interaction.”. Applicants then investigate whether there is evidence that the insights from the lab data apply to a real-world context by using data from the field. The firm Applicants work with uses a sophisticated ensemble machine learning method to prepare forecasts; examining whether the relatively simple forecast integration methods Applicants propose could improve the performance of this state-of-the-art model was particularly interesting. In addition, the timeframe Applicants conducted the field study coincides with the COVID-19 pandemic, where human forecasters had private information outside the data used by the model. The pandemic is an excellent example of unprecedented demand, and human forecasters have additional knowledge that can improve accuracy if incorporated correctly.

Applicants' research shows that integrated forecasts (that blend human judgment with analytics) can substantially improve accuracy compared to non-integrated forecasts. In other words, human judgment provides significant accuracy benefits in demand planning. In addition, Applicants find that this accuracy improvement depends on the integration method. Human-Guided Learning and Integrative Judgment Learning are the most effective methods of integration in comparison to the other methods. These two simple integration methods are easy to implement; they enhance forecasting performance, even in a retail firm's real-world context, employing a sophisticated ensemble machine learning approach to forecasting.

### Example 1.2. Literature

Judgmental Adjustment. Judgmental Adjustments are revisions to a forecast that rely on human judgment; due to the risks of judgment biases, researchers have examined best practices when engaging in Judgmental Adjustment. A common argument in the literature is that only experts should adjust forecasts, as higher levels of expertise lead to improved forecast accuracy. It has been shown that Judgmental Adjustments generally improve accuracy when: 1) adjustments are more extensive and 2) adjustments negatively correlate with the forecast (i.e., downward adjustments for relatively large forecasts and upward adjustments for relatively low forecasts). Some argue that experts should pair their judgmental adjustments with a specific bias correction strategy after significant forecast errors. Researchers propose to impose thresholds below which forecast adjustments should not be allowed. Additionally, during post-promotional periods, there is evidence that human forecasters need structured support to make effective adjustments.

Quantitative Correction. Theil's correction is a standard Quantitative Correction method and separates judgmental forecasts' mean square error (MSE) into two types of bias: mean and regression. Theil refers to the mean bias as the historical tendency of a forecaster to overestimate or underestimate when forecasting. Theil uses regression bias to represent a systematic inability to detect the trendline. Theil demonstrates that regression of actuals on the forecasts removes both the mean and regression biases from past forecasts. Theil proposes that his method should remove the same biases (assuming they are systematic) from future forecasts. Studies have since empirically tested Theil's correction and recommend its use for better accuracy in demand planning.

Fildes proposes a different method of Quantitative Correction that applies when forecasters have access to information that the model cannot include. The Fildes method defines four determinants of forecast errors: “an inadequate weighting in the forecast of the economic determinants of output; an implicit causal model which is misspecified, inaccurate forecasts of the determinants of output; and random shocks”. The method is based on a combination of bootstrapping and expectation formation, using a regression model with a series of lagged variables to correct for the error. Researchers have tested the Fildes method and demonstrate that it can increase forecast accuracy in practice. Although research indicates Quantitative Correction may aid in increasing forecast accuracy, it is currently not a popular applied method.

Forecast Combination. Blattberg and Hoch recommend using an equal-weighted average combination as an integration method. They cite three advantages of this approach: (a) simplicity—managers do not need to understand or develop models, so the natural organizational separation of modelers and managers can continue; (b) palatability—managers retain a considerable amount of control over the decision-making process; and (c) accuracy, a combination of model and manager will be more accurate than the individual decision inputs. Franses and Legerstee use a case study to test the accuracy of the Blattberg-Hoch method of combination and conclude that combination is more accurate than either the judgmental forecast or model-based forecast in isolation. However, Fildes offer evidence that the equal-weighted average combination is suboptimal in practice given the tendency of forecasters to under-adjust; they anchor on the statistical forecast and insufficiently adjust from the statistical forecast.

Input to Model-Building. Sanders and Ritzman argue that Input to Model-Building offers objective and unbiased integration of human judgment and system-generated model forecasts. Despite this endorsement, there is little empirical evidence of the efficacy of the Input to Model-Building method. Existing research demonstrates that Input to Model-Building can improve forecast accuracy under specific circumstances. Rule-based forecasting (RBF) implements Input to Model-Building, relying on expert human judgment and historical time series to develop rules that become inputs to a model. This method is helpful for complex forecasting scenarios. Judgmental model selection is another implementation of Input to Model-Building utilizing human judgment for model selection. It can outperform the automatic selection of variables regarding systematic variability, such as trend and seasonality. In this study, Applicants use human judgment as an input to the model by estimating the effect of special events.

Integrative Judgment Learning. Applicants can apply a linear regression model using the model forecast and a Judgmental Adjustment in each period to dynamically estimate systematic bias in the Judgmental Adjustments. Thus, when a human manager adjusts in a demand planning period, the forecasting system can correct this estimated bias to arrive at a more accurate forecast. Applicants refer to this technique as Integrative Judgment Learning. Researchers have demonstrated that a judgmental forecast, included as a predictive variable in the forecasting model, can improve forecast accuracy for time series with high uncertainty. Applicants' research operationalizes the method using Judgmental Adjustments in previous periods as a predictive variable in a regression model.

Human-Guided Learning. The new method of integration Applicants propose, Human-Guided Learning, treats the Judgmental Adjustments in previous periods as an informational cue. Rather than use the values input by the human, Human-Guided Learning uses the cue as an indicator variable in a model that estimates the appropriate adjustment based on the cue. Applicants provide the theoretical rationale behind Human-Guided Learning in the next section.

TABLE 2
Summary of Existing Forecast Integration Methods

| Forecast Integration | | How often used |
|---|---|---|
| Methods | Definition | in Practice* |
| Judgmental Adjustment (JA) | Any adjustment made by a forecaster to the | 44.8% |
| | output of an algorithmic forecast. | |
| Quantitative Correction (QC) | An automated system that monitors | 14.9% |
| | judgmental forecasts and uses any detected | |
| | bias in past forecasts to adjust the next period | |
| | forecast. | |
| Forecast Combination (FC) | The equal-weighted average of independent | 23.9% |
| | judgmental and model-based forecasts. | |
| Input to Model-Building (IM) | Judgment in the forecasting period is used to | N/A |
| | build a quantitative model by selecting | |
| | variables, model specification, and parameter | |
| | estimation. | |
| Integrative Judgment | Judgment in previous periods is used as a | N/A |
| Learning (IJL) | predictive variable in a model. | |

*The other 16.4% of respondents relied on either exclusively human judgment (13.4%) or solely statistical models (3%) to forecast.

### Example 1.3. Theoretical Development

Prior pairwise comparisons among these integration methods have yielded mixed results. For example, Forecast Combination is more accurate than Judgmental Adjustments. However, Judgmental Adjustments outperform Forecast Combination when experts make adjustments. Blattberg and Hoch identify the limitations of their method by stating that “until more is known about how to build better models, the [equal-weighted average] decision heuristic is a nonoptimal but pragmatic solution”.

Preparing a forecast requires (a) identifying systematic variation in past data (e.g., level, trend, and seasonality), (b) separating such systematic variation from noise, (c) determining how stable (and thus useful for prediction) such systematic variation is, and (d) incorporating any additional unsystematic variation that can affect the forecast of a particular period (e.g., promotions, pandemic events, etc.). Applicants' theoretical argument is that models excel at (a) to (c), whereas human judgment excels at (d). Any integration method that incorporates this insight and focuses human judgment on (d) and removes it from (a) to (c) should lead to better forecasting outcomes.

Input to Model-Building is such an integration method. Specifically, the technique only asks forecasters to identify an additional quantity that should be added or subtracted from the forecast due to exceptional circumstances; separating signal from noise in past time-series data is left to the forecasting algorithm. Other integration methods, such as Judgmental Adjustment, Quantitative Correction, and Forecast Combination, do not explicitly focus on the input of human forecasters on (d). However, despite being an up-and-coming integration method, Input to Model-Building has yet to be extensively empirically tested. In one of the few empirical studies of this method, Nakano and Oji provide a case study that documents improved forecast accuracy with Input to Model-Building.

Since the complementary strengths of humans and models are better utilized in Input to Model-Building vis-à-vis the other integration methods, Applicants expect that Input to Model-Building will be more accurate. Formally:
HYPOTHESIS 1: Input to Model-Building results in improved forecast accuracy compared to Judgmental Adjustment, Quantitative Correction, and Forecast Combination.

Extending on Input to Model-Building, Integrative Judgment Learning separates the strengths and weaknesses of humans and models. Specifically, the method allows forecasters to identify private information regarding special events and then allows the model to detect trends, weigh evidence, and systematically integrate all the available data. While Input to Model-Building takes the input of a forecaster as given, Integrative Judgment Learning will compare such input to past input and weigh it according to its past usefulness in forecasting.

In terms of incorporating information into a forecast, one can differentiate between the strength of evidence—i.e., the extent to which the future is different from the past based on new information—and the weight of evidence—i.e., the trust that a forecaster should place in this information leading to a more accurate forecast. Griffin and Tversky and Massey and Wu introduced these two concepts to the science of decision making. At the risk of over-simplifying, think of effect size in a regression model as a measure of the strength of evidence and the standard error of this effect as a measure of the weight of evidence. Another classic example is a biased coin flip; the proportion of heads or tails represents the strength of evidence, and the sample size signifies the weight of evidence. Throwing four heads on five flips is a signal with high strength and low weight while throwing 33 heads out of 60 flips has low strength but high weight.

In Applicants' context, the strength of evidence represents an event's possible effect on a particular forecast. The weight of evidence signifies how much trust a forecaster can have that this information will lead to a more accurate forecast. Suppose you consider point forecasting under squared deviation accuracy metrics. In that case, an event that causes a sudden demand of 100 units (strength) with a 10% chance (weight) should have a similar impact on a point forecast as an event that causes a sudden demand of 10 units with a 100% chance. The product of the strength and the weight of evidence determines the shift in point forecasts.

The core of Applicants' theoretical argument is that humans and algorithms differ in their ability to capture the strength and the weight of evidence. Human forecasters can synthesize many different and uncodified sources of information into a signal and determine the strength of that signal. They will focus on this strength of evidence, with the weight of evidence becoming a secondary concern. As a result, they generally do not sufficiently account for the noise in their data. Algorithms can only capture codified information and thus have a challenge to adequately determine the strength of a signal or even that a signal is present. Still, they have less difficulty properly reflecting the weight of evidence in a documented signal.

To adequately incorporate special events into a forecast, one needs to (a) know that the event may occur, (b) estimate the strength of the signal, i.e., how much impact this event has on demand, and (c) understand the weight of evidence underlying the predicted event. Applicants argue that humans excel at (a) since this task requires a broad environmental scanning and integrative understanding of the market and the organization; models may lack the proper input of codified data. Humans are also better at (b) than at (c)—which Applicants hypothesize in Hypothesis 2—though models may ultimately also be better at (b) and (c) than humans, which Applicants will hypothesize in Hypothesis 3.

The primary advantage of Integrative Judgment Learning is to focus the human forecaster further on estimating the strength of a signal while leaving the estimation of the weight of that signal to an algorithm. Most other integration methods, like Judgmental Adjustment, Quantitative Correction, Forecast Combination, and Input to Model-Building, require the human forecaster to juggle multiple components and estimate the strength of a signal. The integration methods that rely on judgmental forecasts (Quantitative Correction and Forecast Combination) are even more burdensome for forecasters. They need to identify systematic variation in past data (e.g., levels, trend, and seasonality), separate such systematic variation from noise, determine how stable (and thus useful for prediction) such systematic variation is, and establish the strength and weight of the private information. The many parts of the forecasting process and associated strengths/weights estimations are all grouped into the judgmental forecast, making separating the various biases present in the forecast more difficult for a model to detect. In contrast, when using Integrative Judgment Learning, the forecaster only needs to determine the strength of any additional private information. An algorithm can then weigh the evidence more precisely.

Human forecasters can better diagnose and predict special events, evaluate and incorporate subjective factors, adapt to changing conditions, and recognize and interpret abnormal cases. But they are at a disadvantage in correctly estimating an event's likelihood and, thus, how strongly it should impact a point forecast. Integrative Judgment Learning allows the model to optimally estimate the weight of evidence by using similar past judgments made by the forecaster, thereby removing human bias in producing a forecast. Applicants, therefore, expect Integrative Judgment Learning to lead to more accurate forecasts through iterative integration and interaction of the strengths of human judgment and models. Specifically:
HYPOTHESIS 2: Integrative Judgment Learning results in improved forecast accuracy compared to Judgmental Adjustment, Quantitative Correction, Forecast Combination, and Input to Model-Building.

While humans are better at estimating the strength than the weight of evidence, models could theoretically be better at this task if given a proper taxonomy of events and past data. For example, a human forecaster may know that a promotion will occur. They will be able to come up with an estimate for how much this promotion will affect a particular product. Still, if given proper data, an algorithm can examine all past similar promotions and estimate how such an event should influence the forecast. Thus, for Applicants' last hypothesis, Applicants narrow the scope of Integrative Judgment Learning and introduce Human-Guided Learning. Humans provide the model with information that an event is occurring but leave the estimation of the impact of that event to the algorithm.

According to Fildes, humans often misinterpret private information, which leads to inaccurate estimations. As such, Applicants propose Human-Guided Learning as a method of forecasting that does not rely on human judgment to estimate the strength or weight of private information. Human-Guided Learning differs from Integrative Judgment Learning by requiring the forecaster to signal private information through a binary cue (e.g., indicating to the model that it is a period with a special event) rather than by providing the strength of the private information (as in Integrative Judgment Learning). In other words, the human forecaster codifies whether a special event will occur in the forecasted period and relies on the algorithm to estimate the strength and weight of that information.

Human-Guided Learning being beneficial compared to Integrative Judgment Learning seems counter-intuitive; it essentially means that Applicants limit how forecasters can provide information to the model. Why should such a limitation lead to enhanced performance? The idea is that this is what humans do best—they can catalyze what they observe in the market and thereby codify what special event should influence the forecast. An algorithm, in turn, can look at similar past events to convert the codified information into an actual signal by estimating the strength and weight of the information and incorporating both into the forecast. Suppose forecasters are better at judging whether certain events will occur, but algorithms excel at understanding what these events mean for forecasting. In that case, Human-Guided Learning should provide possible performance improvements compared to Integrative Judgment Learning. Leaving this task to humans will introduce noise into the forecast that can be removed by entrusting the algorithm. Thus, Applicants posit that Human-Guided Learning will be the optimal process to maximize the value of private information and minimize biases. Formally:
HYPOTHESIS 3: Human-Guided Learning results in improved forecast accuracy compared to Judgmental Adjustment, Quantitative Correction, Forecast Combination, Input to Model-Building, and Integrative Judgment Learning.

### Example 1.4. Study 1: Laboratory Experiment

Experimental Design. This study assessed the accuracy of various methods of integrating participants' and models' repeated forecasts over a time series forecasting task. Since this research aims to identify which method of integration best utilizes the strengths of humans combined with models to improve accuracy, Applicants designed the laboratory experiment to highlight the strengths of each. Prior literature has documented that models excel at detecting trends. Complementarily, humans are best at identifying special events and utilizing available private information to forecast demand. Therefore, Applicants generate the time series for each participant i using a positive trendline with low noise while incorporating demand shocks due to special events (which allowed participants to use private information).

Demand Generating Process. Applicants calculated the demand trendline for each participant i using an intercept of 100 (to ensure all demand was positive) with a slope of five. Applicants generated the error from a discrete uniform distribution X˜U (−3, 3). The demand shocks occurred during the same periods for all participants to allow for better comparability (Schweitzer & Cachon, 2000). However, since the participants were unaware of the timing, the shocks appeared to them as random. Since the goal of the experimental design was to emphasize an environment where judgment can improve forecast accuracy, Applicants created the magnitude of the demand shocks to be three standard deviations above the trendline. Applicants randomly generated the extent of each shock from the discrete distribution {35, 37, 39, 41, 43, 45, 47}.

The demand-generating process for the time series of individual i at time t (ACTUAL_{i, t}) for PERIOD_{i, t} with SHOCK_{i, t} is described by Equation E1.1 below.

$${ACTUAL}_{i , t} = {β}_{0} + {β}_{1} {PERIOD}_{i , t} + {SHOCK}_{i , t} + {ε}_{i , t} \qquad ( E1 \text{.1} )$$

The experimental task was programmed using oTree, an open-source Python framework capable of creating interactive behavioral economic experiments. The task began with two training periods where participants observed ten historical demand observations of the time series and an output of the system forecast for the upcoming period for each participant i. The system forecast (SF_{i, t}) used throughout the experiment was a simple trend prediction defined as follows:

$$S {F}_{i , t} = {β}_{0} + {β}_{1} {PERIOD}_{i , t} \qquad ( E1 \text{.2} )$$

In other words, Applicants assumed that the system had already perfectly estimated the parameters of the demand-generating process.

During training, Applicants asked the participants a series of three questions: 1) What is the model's forecast?2) How much do you want to change the model forecast? and 3) What is your forecast? Participants were unable to advance until after they had answered the questions correctly. Following training, Applicants instructed participants that the actual task had begun. Participants first observed a time series of 10 historical demand observations to observe the data pattern without the shocks. This initial period allowed participants to realize that the data was non-stationary but did not compromise the experimental manipulations by displaying the effects of the shocks. Applicants then asked them to enter their forecast or adjustment (depending on the condition) for the upcoming period. After the participants clicked “Next” the time series was updated to show the actual demand, the forecast, and feedback regarding their accuracy. The time series with all past demand observations and forecasts and their accuracy was available throughout all periods. In each period before a demand shock, participants receive a message indicating that there will be a special event affecting demand in the next period. Applicants then showed participants a probability distribution of the magnitude of the shock. The forecasting process was repeated for 30 periods, resulting in 40 periods of demand observations (10 historical+30 forecasted).

Methods of forecasting and integration. The experiment had six conditions requiring participant interaction: Judgmental Forecast, Judgmental Adjustment, Quantitative Correction, Input to Model-Building, Integrative Judgment Learning, and Human-Guided Learning.

Applicants define JF_{i, t} as the Judgmental Forecast entered by participant i at time t. In the J_{i, t} condition, participants do not see output from the system forecast. In the Judgmental Adjustment condition, participants observed the system forecast for the upcoming period. Applicants then asked them for their forecast (allowing participants to use the system forecast as a benchmark and adjust if desired). The QC condition used a simplified version of Theil's correction. In QC, the judgmental forecast for individual i at time t is corrected using the error in prior judgmental forecasts as follows:

$$Q {C}_{i , t} = J {F}_{i , t} \pm \frac{1}{t - 1} {\sum }_{j = 1}^{t - 1} J {F}_{j , t} - {ACTUAL}_{j , t} \qquad ( E1 \text{.3} )$$

The Input to Model-Building condition asked participants to enter a quantity adjustment to demand (ADJ_{i, t}) for the upcoming period without knowing the system forecast. Applicants asked participants to estimate the effect of special events. Since the minimum shock was over three standard deviations above the trend, it would not be logical for participants to decrease the forecast during the shocks. As such, Applicants constrained the quantity to be non-negative.

$$I {M}_{i , t} = S {F}_{i , t} + {ADJ}_{i , t} \qquad ( E1 \text{.4} )$$

Integrative Judgment Learning differed from Input to Model-Building in that the model includes the adjustment to demand as a predictive variable. In other words, in Input to Model-Building, Applicants incorporated the quantity adjustment into the forecast with a weight of one. In contrast, in Integrative Judgment Learning, the weight of the adjustment quantity was determined by linear regression between past demand, periods, and adjustments (Equation E1.5). As with IM, Applicants constrain the adjustment quantity ADJ_{i, t} to be non-negative.

$$I J {L}_{i , t} = {α}_{0} + {α}_{1} S {F}_{i , t} + {α}_{2} {ADJ}_{i , t} \qquad ( E1 \text{.5} )$$

Lastly, Human-Guided Learning replaces the quantity of the adjustment with a binary indicator to denote whether the upcoming period will have a special event:

$$H G {L}_{i , t} = {α}_{0 , iT} + {α}_{1} S {F}_{i , t} + {α}_{2} {CUE}_{i , t} \qquad ( E1 \text{.6} )$$

$$Here , {CUE}_{i , t} = \{ \begin{matrix}0 if ADJi , t = 0 \\ 1 if ADJi , t \neq 0\end{matrix}$$

Applicants used an iterative multivariate linear regression algorithm for Integrative Judgment Learning and Human-Guided Learning models. The entire regression equation was re-estimated dynamically in each period for each participant. This iterative estimation allowed the integration models to learn from the previous periods and the participants' input.

Following the collection of the data, Applicants also recorded the SF, and Applicants calculated the Forecast Combination (FC_{i, t}) following Blattberg and Hoch as the simple equal-weighted average of the SF and JF:

$$F {C}_{i , t} = 0 \text{.5} S {F}_{i , t} + 0 \text{.5} J {F}_{i , t} \qquad ( E1 \text{.7} )$$

Forecast Accuracy Measures. Applicants use the Mean Absolute Scaled Error (MASE) as Applicants' primary outcome variable. Applicants chose MASE since the experiments and field study have time series of different scales, and Applicants wanted to use a metric that would allow for straightforward comparisons. MASE is also the standard performance metric used in forecasting since it is less sensitive to outliers than other accuracy measures. To calculate MASE for the forecasts of each method of integration, Applicants followed Hyndman and Koehler to calculate the scaled errors by dividing error by the in-sample average one-step naïve forecast of the training dataset j (Equation E1.8):

$$M A S E = \frac{1}{T} {\sum }_{t = 1}^{T} \vert \frac{{ACTUAL}_{i , t} - {FORECAST}_{i , t}}{\frac{1}{s - 1} {\sum }_{t = 2}^{s} \vert {ACTUAL}_{j , t} - {ACTUAL}_{j , t - 1} \vert} \vert \qquad ( E1 \text{.8} )$$

Where s is the length of the training dataset.

Applicants also calculated the root mean squared scaled error (RMSSE) for robustness (Equation E1.9). RMSSE is a variant of MASE that is also scale-independent. RMSSE is more appropriate for intermittent demand. RMSSE is also scaled using the in-sample one-step naïve forecasts of the training dataset:

$$R M S S E = \sqrt{\frac{\frac{1}{T} {\sum }_{t = s + 1}^{T} {( {ACTUAL}_{i , t} - {FORECAST}_{i , t} )}^{2}}{\frac{1}{s - 1} {\sum }_{t = 2}^{s} {( {ACTUAL}_{j , t} - {ACTUAL}_{j , t - 1} )}^{2}}} \qquad ( E1 \text{.9} )$$

Applicants added the scaled mean absolute percentage error (sMAPE) as a robustness measure as it is a standard measure used in the retail industry and the metric used by Applicants' partner firm. Applicants also include the mean absolute percentage error (MAPE) for robustness.

$$s M A P {E}_{i} = \frac{100}{T} {\sum }_{t = 1}^{T} \frac{\vert {ACTUAL}_{i , t} - {FORECAST}_{i , t} \vert}{( {FORECAST}_{i , t} + {ACTUAL}_{i , t} ) / 2} \qquad ( E1 \text{.10} )$$

$$M A P E = \frac{100}{T} {\sum }_{t = 1}^{T} \frac{\vert {ACTUAL}_{i , t} - {FORECAST}_{i , t} \vert}{{ACTUAL}_{i , t}} \qquad ( E1 \text{.11} )$$

Participants. Applicants conducted Applicants' experiment using an online platform and undergraduate students at a large American private university. Applicants collected responses from 353 subjects, each completing one set of forecasts (i.e., forecasts for 30 periods). To increase the validity of Applicants' experiment, Applicants used a lottery performance-based incentive. Upon beginning the task, Applicants told participants that Applicants would randomly select five who completed the exercise to win the amount they earned. Applicants showed the amount they could win to all participants. Applicants calculated the payout (Equation E1.12) using an $11 show-up payment plus up to $9 additional compensation based on participants' individual Mean Absolute Error (MAE) following previous literature. The average bonus for Applicants' sample is $4.44 out of the possible $9.

$$Total Possible Payout = \$11 + [ \$9 - ( 0.2 * M A E ) ] \qquad ( E1 \text{.12} )$$

The collection of responses resulted in 10,590 observations (353 sets of forecasts×30 forecasted periods). Following the data collection, Applicants used JF and SF to calculate FC and replaced the JF observations with FC. Applicants split the sample into sections for Applicants' analysis. Applicants removed forecasts for periods 11-20 of the set before the analysis to allow for learning effects and training the model. Applicants also dropped all forecasts for the periods with no shocks since Applicants are predominantly interested in those forecast periods where private information provides additional value. In summary, the total number of forecasts in the sample used for Applicants' analysis was 3,530 (353 sets×10 periods). Following prior research, Applicants winsorized the forecasts at the 5% and 95% percentile. Applicants then aggregated forecast errors (in shocked periods only) to the participant to achieve the independence of units. Therefore, Applicants' final dataset for Study 1 contained 353 observations.

Analysis. Applicants tested Applicants' hypotheses by comparing methods of integration. An assessment of the data revealed a non-normal distribution (D(463)=0.15, p<0.001 and W(352)=0.94, p<0.001). As such, Applicants used a Generalized Linear Model (GLM) with a robust covariance function and specified a gamma distribution. This approach is appropriate given that Applicants' data comprises non-negative values and exhibits a positively skewed unimodal distribution. Applicants also estimated the model using an identity link function, and there was no significant difference in the Akaike's Information Criterion (AIC) and Bayesian Information Criterion (BIC) results. The results reported in Table 3 are estimated using a log link function.

TABLE 3
Accuracy Statistics for Laboratory Experiment

| | | MASE | | RMSSE | | sMAPE* | | MAPE* | |
|---|---|---|---|---|---|---|---|---|---|
| | | | Std. | | Std. | | Std. | | Std. |
| | N | Mean | Dev. | Mean | Dev. | Mean | Dev. | Mean | Dev. |
| Judgmental | 46 | 0.38 | 0.15 | 0.42 | 0.15 | 5.38 | 2.02 | 5.30 | 1.94 |
| Adjustment | | | | | | | | | |
| Quantitative | 71 | 0.56 | 0.36 | 0.61 | 0.33 | 7.26 | 4.12 | 6.85 | 3.72 |
| Correction | | | | | | | | | |
| Forecast | 48 | 0.43 | 0.25 | 0.55 | 0.27 | 6.00 | 3.48 | 5.69 | 3.18 |
| Combination | | | | | | | | | |
| Input to Model- | 58 | 0.49 | 0.27 | 0.51 | 0.25 | 6.22 | 3.03 | 6.37 | 3.12 |
| Building | | | | | | | | | |
| Integrative | 61 | 0.31 | 0.14 | 0.34 | 0.14 | 4.23 | 1.86 | 4.10 | 1.78 |
| Judgment Learning | | | | | | | | | |
| Human-Guided | 69 | 0.31 | 0.13 | 0.34 | 0.13 | 4.28 | 1.73 | 4.15 | 1.65 |
| Learning | | | | | | | | | |

*Units are percent (%).
The bolded values are for the primary analysis.
The other measures of forecast accuracy (RMSSE, SMAPE, and MAPE) are for robustness.

Hypothesis 1 predicted that Input to Model-Building would be more accurate than Judgmental Adjustment, Quantitative Correction, and Forecast Combination. Model 1 in Table 4 tests Hypothesis 1 using Input to Model-Building as the fixed factor and reveals that Input to Model-Building is not the most accurate method among the ones included in the model. This finding is robust across all the forecast accuracy measures listed. Thus Hypothesis 1 is not supported.

TABLE 4
GLM Results for Laboratory Experiment.

| | Model 1 | | Model 2 | | Model 3 | |
|---|---|---|---|---|---|---|
| | Estimate | SE | Estimate | SE | Estimate | SE |
| Intercept | −0.72** | (0.07) | −1.18* | (0.06) | −1.17** | (0.05) |
| Judgmental | −0.26** | (0.09) | 0.20** | (0.08) | 0.19** | (0.08) |
| Adjustment | | | | | | |
| Quantitative | 0.14 | (0.10) | 0.59** | (0.10) | 0.59** | (0.09) |
| Correction | | | | | | |
| Forecast | −0.13 | (0.11) | 0.33** | (0.10) | 0.33** | (0.10) |
| Combination | | | | | | |
| Input to Model- | (omitted) | (—) | 0.46** | (0.09) | 0.45** | (0.09) |
| Building | | | | | | |
| Integrative | | | (omitted) | (—) | −0.01 | (0.08) |
| Judgment Learning | | | | | | |
| Human-Guided | | | | | (omitted) | (—) |
| Learning | | | | | | |
| Scale factor | 0.31 | | 0.30 | | 0.27 | |
| Likelihood Ratio | 15.29** | | 44.88** | | 71.84** | |
| Chi-Square | | | | | | |
| N | 223 | | 284 | | 353 | |

*p < 0.05, **p < 0.01.
Applicants calculated the scale factor using the Pearson chi-square.

Hypothesis 2 posits that Integrative Judgment Learning would be more accurate than the previously listed integration methods. Model 2 in Table 4 tests Integrative Judgment Learning as the fixed factor and reveals that Integrative Judgment Learning is significantly more accurate when compared to Judgmental Adjustment, Quantitative Correction, Forecast Combination, and Input to Model-Building. This result supports Hypothesis 2. The findings are robust regardless of the forecast accuracy measure.

Hypothesis 3 states that Human-Guided Learning would be the most accurate integration method. Model 3 in Table 4 uses Human-Guided Learning as the fixed factor. The results indicate that Human-Guided Learning is significantly more accurate than all integration methods other than Integrative Judgment Learning. The findings are robust regardless of the forecast accuracy measure and do not support Hypothesis 3. However, Human-Guided Learning does not lead to inferior performance compared to Integrative Judgment Learning despite limiting the information participants can input into the model.

Robustness. The purpose of Study 1 is to utilize a controlled experiment to identify which method of integration effectively captures the strengths of both humans and models to improve accuracy. As such, the time series generated for the experiment provided an environment geared toward the strengths of both models (positive trendline with low noise) and humans (incorporating demand shocks due to special events, allowing participants to use private information). The resulting time series had a low coefficient of variation (0.13). While the experiment adequately achieved its purpose, a simple forecasting environment with such low noise levels may not mirror reality. Therefore, Applicants designed an additional experiment to increase external validity.

Applicants analyzed the field data Applicants used in Study 2. The field data revealed coefficients of variation averaging between 0.48 to 1.50. Applicants adjusted the parameters used to generate the robustness-check time series and demand shocks to achieve a coefficient of variation of 1.02, like the field data. Specifically, Applicants derived demand using an intercept of 10 (to ensure all demand was positive) with a level model. Applicants generated the error from a discrete uniform distribution X˜U (0, 20). The demand shocks followed the exact timing of the main experiment. However, Applicants increased the magnitude of the shocks by randomly generating them from the discrete distribution {35, 45, 55, 65, 75, 85, 95}.

The experimental task remained the same in every aspect as the prior experiment, other than a different data generation process and larger shocks. Rather than retesting all integration methods—given there was no significant difference between Judgmental Adjustment, Quantitative Correction, Forecast Combination, and Input to Model—Applicants assigned all participants to Judgmental Adjustment. Applicants calculated Integrative Judgment Learning and Human-Guided Learning ex-post. Participants were recruited from the same American private university and received the same lottery performance-based incentives. The collection of responses resulted in 95 participants. Applicants calculated Integrative Judgment Learning and Human-Guided Learning forecasts and added them to the dataset. Applicants followed the same data cleaning, winsorizing, and aggregating process as the main experiment. The final dataset for the robustness experiment was 285 observations. Accuracy statistics are summarized in Table 5.

TABLE 5
Accuracy Statistics for Robustness Experiment

| | | | | RMSSE | | SMAPE* | | MAPE* | |
|---|---|---|---|---|---|---|---|---|---|
| | | MASE | | | Std. | | Std. | | Std. |
| | N | Mean | Std. Dev. | Mean | Dev. | Mean | Dev. | Mean | Dev. |
| Judgmental | 95 | 0.89 | 0.33 | 0.82 | 0.27 | 73.56 | 33.26 | 50.14 | 18.00 |
| Adjustment | | | | | | | | | |
| Integrative | 95 | 0.47 | 0.13 | 0.47 | 0.13 | 26.99 | 7.82 | 29.82 | 9.02 |
| Judgment | | | | | | | | | |
| Learning | | | | | | | | | |
| Human-Guided | 95 | 0.60 | 0.11 | 0.57 | 0.10 | 39.73 | 6.73 | 31.97 | 4.59 |
| Learning | | | | | | | | | |

*Units are percent (%).
The bolded values are for the primary analysis.
The other measures of forecast accuracy (RMSSE, SMAPE, and MAPE) are for robustness.

Applicants again used GLM with a gamma distribution for the robustness experiment following the same steps used in the primary analysis of Study 1. Model 1 in Table 6 estimates the comparison of Integrative Judgment Learning and Judgmental Adjustment. The results confirm Applicants' findings from Study 1—Integrative Judgment Learning is significantly more accurate than Judgmental Adjustment. Model 2 in Table 6 compares Judgmental Adjustment, Integrative Judgment Learning, and Human-Guided Learning and reveals that Human-Guided Learning is more accurate than Judgmental Adjustment; however, Integrative Judgment Learning is more accurate than Human-Guided Learning.

TABLE 6
GLM Results for Robustness Experiment.

| | Model 1 | | Model 2 | |
|---|---|---|---|---|
| | Estimate | SE | Estimate | SE |
| Intercept | −0.75** | (0.03) | −0.51** | (0.02) |
| Judgmental Adjustment | 0.63** | (0.05) | 0.40** | (0.04) |
| Integrative Judgment Learning | (omitted) | (—) | −0.24** | (0.03) |
| Human-Guided Learning | | | (omitted) | (—) |
| Scale factor | 0.11 | | 0.08 | |
| Likelihood Ratio Chi-Square | 173.12** | | 234.56** | |
| N | 190 | | 285 | |

*p < 0.05,
**p < 0.01.
Applicants calculated the scale factor using the Pearson chi-square.

In summary, Study 1 revealed that forecasting accuracy differs across integration methods. Specifically, Integrative Judgment Learning and Human-Guided Learning significantly improved forecasting accuracy compared to the existing integration methods. The robustness experiment confirmed that Integrative Judgment Learning and Human-Guided Learning are more accurate even during environments with higher noise. These results support Hypothesis 2 but not Hypotheses 1 and 3. Applicants next test how Integrative Judgment Learning and Human-Guided Learning compare to existing methods when used by demand planners in practice.

### Example 1.5. Study 2: Field Study

Design. This field study assessed the accuracy of various methods of integrating expert demand planners' and models' weekly forecasts. Field studies are an attractive method to study behavior since the researchers maintain control (internal validity) while retaining realism (external validity) without the subjects knowing they are being studied. Since the purpose of Study 2 is to provide generalizability and test the novel method of integration in a real-world retail setting, Applicants selected an industry partner that would guarantee forecasts made in rapidly changing markets with many thousands of SKUs and store locations. Applicants identified Applicants' industry partner by ensuring the firm was a large retailer with a large pool of historical data regarding actual sales, adjustments, reasons for adjustments, a broad range of adjustment sizes, and varying levels of uncertainty in demand.

Applicants conducted the field study over 30 weeks (February-September 2020). The study occurred within this timeframe since Applicants' partner firm introduced their ensemble machine learning (ML) forecasting system in February 2020. In addition, the COVID-19 pandemic offered an excellent example of an event where planners may have private information and demand is highly unpredictable.

The demand planning process introduced by the firm relied on a sophisticated ensemble ML forecasting system and human demand planners. The forecasting system employed ML algorithms, including gradient-boosting optimization, Gaussian processes, and hierarchical modeling. The ML algorithms had many features (i.e., additional explanatory variables used for prediction), including historical promotions, inventory, and seasonality. Forecasts were prepared eight weeks in advance using a four-to-six-week forecast horizon. Applicants tasked demand planners with reviewing the ML system demand forecast at the product-store level each week. They could adjust the ML system forecast. If the demand planners revised the ML system demand forecast, Applicants asked them to identify the primary (and potentially secondary) reasons for adjusting. The firm indicated that the primary reason identified by the planners was the most relevant, and the secondary reasons were frequently nebulous. Therefore, the firm suggested Applicants focus only on the primary reason specified. The field study contains three groups: 1) the existing method of integration-Judgmental Adjustment-used by the firm, 2) Integrative Judgment Learning, and 3) Human-Guided Learning.

Methods of integration. Applicants calculated all three integration methods following the same procedures as in Study 1 with slight model modifications. Whereas Study 1 only allowed one type of reason to adjust the system forecast, the field study had ten unique primary reasons the system forecast was adjusted (Table 7). These ten primary reasons are: 1) Weather, 2) Demand shift to new store (New store), 3) Phantom inventory, 4) Summer vacations, 5) Store-specific events, 6) Firm-wide events, 7) Large discount events, 8) Bundle promotions, 9) Discounted prices, and 10) Adjustments to the model such as a consistent over/under forecast (Model). In a separate regression, Applicants calculate the Integrative Judgment Learning and Human-Guided Learning forecasts for each adjustment reason. Both models used ten weeks of training data before forecasting.

Dataset. Applicants' dataset contained 3,974,484 weekly demand forecasts at the product-store level. The dataset also included the unit sales, adjustments, and primary reason for adjustment at the product-store level for each weekly demand forecast. Applicants split the dataset into sections for Applicants' analysis. Applicants used the first ten weeks of data for all weekly product-store combinations to train the models. The remaining weeks for each product-store combination were aggregated to the product-store level to allow for independence in observations. In summary, the total number of weekly demand forecasts used in Applicants' analysis was 2,346,255, which, once aggregated, resulted in 219,363 product-store level observations (with each treatment group consisting of 73,121 observations). Applicants provide an overall summary of the data in Table 7.

TABLE 7
Size of Relative Adjustments by Reason.

| | N | N | | | | Wins. | | Std. |
|---|---|---|---|---|---|---|---|---|
| | Adjustments | Forecasts | Adj* | Pos.* | Neg.* | Mean* | Median* | Dev.* |
| Reason | | | | | | | | |
| Weather | 11,826 | 338,238 | 3.5 | 18.49 | 0.23 | 7.54 | 7.86 | 2.76 |
| New store | 11,070 | 265,092 | 4.18 | 77.4 | 22.6 | 53.47 | 43.78 | 74.79 |
| Phantom inventory | 72,000 | 827,082 | 8.71 | 100 | 0.00 | 40.4 | 28.95 | 32.72 |
| Summer vacations | 36,549 | 338,238 | 10.81 | 96.45 | 3.55 | 74.76 | 56.36 | 74.55 |
| Store-specific events | 23,499 | 437,184 | 5.38 | 100 | 0.00 | 57 | 45.11 | 54.35 |
| Firm-wide events | 2,889 | 265,092 | 1.09 | 99.38 | 0.62 | 116.2 | 95.08 | 75.02 |
| Large discount events | 2,115 | 338,238 | 0.63 | 98.72 | 1.28 | 35.86 | 32.53 | 27.57 |
| Bundle promotions | 8,388 | 338,238 | 2.48 | 100 | 0.00 | 26.83 | 28.00 | 10.90 |
| Discounted prices | 190,935 | 561,990 | 33.97 | 100 | 0.00 | 41.95 | 34.02 | 39.18 |
| Model | 2,097 | 265,092 | 0.79 | 100 | 0.00 | 162.44 | 139.39 | 108.27 |

Notes.
*Units are percent (%).

Analysis. As with Study 1, an assessment of the data revealed a non-normal distribution. However, unlike Study 1, the distribution contained some cases where the dependent variable was equal to zero, so a Tweedie distribution is more appropriate. Previous studies in retail forecasting have used a Tweedie distribution as sales patterns can follow a non-negative, highly right-skewed distribution. Table 8 summarizes accuracy statistics. Applicants conduct a GLM with a robust covariance function and specify a Tweedie distribution. The results reported in Table 9 are estimated using a log link function. Comparing a log link and an identity link function revealed no significant differences in the AIC or BIC results.

TABLE 8
Accuracy Statistics for Field Study

| | | MASE | | RMSSE | | SMAPE* | | MAPE* | |
|---|---|---|---|---|---|---|---|---|---|
| | | | Std. | | Std. | | Std. | | Std. |
| | N | Mean | Dev. | Mean | Dev. | Mean | Dev. | Mean | Dev. |
| System | 73,121 | 1.02 | 0.51 | 1.01 | 0.58 | 73.76 | 43.00 | 60.12 | 26.63 |
| Forecast | | | | | | | | | |
| Judgmental | 73,121 | 1.04 | 0.51 | 1.02 | 0.58 | 73.96 | 42.92 | 60.81 | 26.73 |
| Adjustment | | | | | | | | | |
| Integrative | 73,121 | 0.96 | 0.43 | 0.93 | 0.43 | 71.18 | 42.06 | 58.58 | 24.10 |
| Judgment Learning | | | | | | | | | |
| Human-Guided | 73,121 | 0.96 | 0.43 | 0.93 | 0.42 | 70.68 | 42.23 | 58.19 | 24.32 |
| Learning | | | | | | | | | |

*Units are percent (%).
The bolded values are for the primary analysis.
The other measures of forecast accuracy (RMSSE, SMAPE, and MAPE) are for robustness.

Model 1 in Table 9 reveals that Integrative Judgment Learning is significantly more accurate than Judgmental Adjustment. Model 2 reveals no significant difference between Integrative Judgment Learning and Human-Guided Learning. These findings are robust regardless of forecasting accuracy measures. While Table 9 does show a slight performance advantage of Human-Guided Learning compared to Integrative Judgment Learning when assessed by SMAPE and MAPE, these differences are not statistically significant.

TABLE 9
GLM Results for Field Study.

| | Model 1 | | Model 2 | |
|---|---|---|---|---|
| | Estimate | (SE) | Estimate | (SE) |
| Intercept | −0.04** | (0.007) | −0.04** | (0.002) |
| Judgmental Adjustment | 0.08** | (0.002) | 0.08** | (0.002) |
| Integrative Judgment Learning | (omitted) | (—) | 0.001 | (0.002) |
| Human-Guided Learning | | | (omitted) | (—) |
| Scale factor | 0.22 | | 0.21 | |
| Likelihood Ratio Chi-Square | 974.55** | | 1389.76** | |
| N | 146,242 | | 219,363 | |

*p < 0.05,
**p < 0.01.
Applicants calculated the scale factor using the Pearson chi-square.

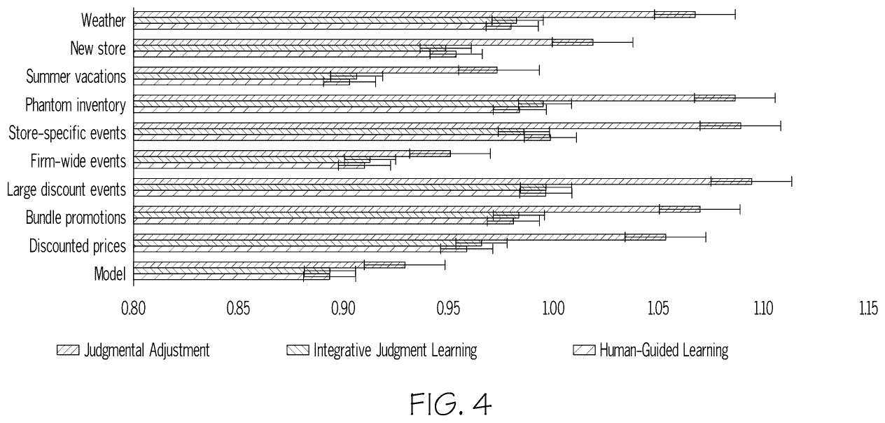

Applicants next split the dataset by adjustment reason because prior literature has shown varying behavior across adjustment reasons. FIG. 4 depicts the performance of Judgmental Adjustment, Integrative Judgment Learning, and Human-Guided Learning for each of the ten adjustment reasons. A Kruskal-Wallis H-Test revealed that Judgmental Adjustment was less accurate for all reasons than Integrative Judgment Learning and Human-Guided Learning. Human-Guided Learning was more precise than Integrative Judgment Learning for the two most adjusted reasons: Discounted prices (H=996.42, SE=526.48, p=0.05) and phantom inventory (H=1565.05, SE=692.64, p=0.02). Discounted prices (n=190, 935) and phantom inventory (72,000) had significantly more adjustments than the other reasons, with a gap of 35,451 to the following most adjusted reason store-specific events (n=36,549).

In summary, Study 2 revealed Integrative Judgment Learning and Human-Guided Learning significantly improved forecasting accuracy compared to the existing method of integration used by the firm (i.e., Judgmental Adjustment). These findings support Hypothesis 2 (i.e., Integrative Judgment Learning vis-à-vis existing integration methods) and further reject Hypothesis 3. However, following posthoc analysis, there are specific conditions—adjustments due to phantom inventory and discounted prices—where Human-Guided Learning was more accurate than Integrative Judgment Learning.

### Example 1.6. Discussion and Conclusion

Applicants' research aimed to compare forecast integration methods in terms of accuracy when humans have access to private information during demand shocks. Another goal was to develop an algorithm for integrating human judgment and models that simultaneously takes advantage of the strengths of human judgment and the strengths of models. Applicants' research shows that a simple new integration method, which takes a cue from forecasters as an input to the model and adjusts the weights attributed to this input dynamically, performs well in the lab. In addition, Applicants' field study of over three million observations adds compelling evidence of the method's generalizability to practice. This new forecast integration method could reduce the absolute percentage error by about three percentage points in a company that uses sophisticated ensemble machine learning techniques for demand forecasting.

Applicants propose and test three hypotheses in Applicants' research. Hypothesis 1 focuses on four existing integration methods and predicts that the Input to Model-Building (IM) method is the most accurate in this set. Counter to Hypothesis 1, Study 1 reveals that Input to Model-Building is less accurate than these other methods. One possible explanation lies in the differentiation of the strength and weight of the information. Input to Model-Building requires the forecaster to determine not only the strength but also the weight of evidence, a task that existing literature has shown humans frequently misjudge.

Hypothesis 2 focuses on Integrative Judgment Learning. As with Input to Model-Building, Integrative Judgment Learning requires the forecaster to provide a change in demand as input to the model. However, counter to Input to Model-Building, this input is weighted by the model before being added to a prediction. Humans may provide highly variable estimates of change, but the model can remove much of the introduced error by reducing the regression weight attached to the adjustment. Therefore, Integrative Judgment Learning leads to improved forecast accuracy compared to the existing integration methods. Study 2 reveals Integrative Judgment Learning improves accuracy compared to Judgmental Adjustment regardless of the demand characteristics. Study 2 further supports Hypothesis 2. These findings align with previous research that has identified that Judgmental Adjustment often does not improve forecast accuracy. Interestingly, by utilizing a different integration method, Applicants find the adjustments can improve the accuracy when used as an input following Integrative Judgment Learning.

Hypothesis 3 compared Human-Guided Learning to the other methods of integration. Human-Guided Learning requires forecasters only to specify that a change will happen; forecasters do not need to select the direction and quantity of this change. Applicants posited if forecasters are better at judging whether particular events will occur or not, but algorithms excel at understanding what these events mean for forecasting, then Human-Guided Learning should be more accurate than the existing methods of integration. Human-Guided Learning generally improves accuracy compared to integration methods other than Integrative Judgment Learning. In Studies 1 and 2, Integrative Judgment Learning and Human-Guided Learning are not significantly different over a short period with few adjustments. However, the field study revealed the two adjustment reasons with the most significant number of observations resulted in Human-Guided Learning outperforming Integrative Judgment Learning. This finding supports the prediction that Human-Guided Learning can be more accurate than Integrative Judgment Learning, given there is enough data to train the model regarding past observations.

The main limitation of Applicants' work is the predictability of the shocks in the experiment. Although Applicants followed prior literature in using equal timing of shocks for all participants to allow for comparability in the experiment, Applicants do not know if Applicants' results would generalize to a less predictable process of demand shocks. However, the field study does have various shocks (special events) that do appear in non-systematic ways (e.g., promotions, demand shifting to new store openings, and weather), which help to provide some evidence as to the generalizability of the findings. This limitation is relevant given that retail forecasting systems do not often effectively incorporate promotions, whether the promotion is predictable or less certain. Applicants' findings appear generalizable to even advanced forecasting systems since the company in Study 2 uses a sophisticated ensemble machine learning system with features including planned and observed historical promotions.

Applicants' work has several more limitations. Applicants could not distinguish which method of integration is best paired with the quality of the forecaster since the forecasts are not independent of the method of integration. Future studies could provide additional insight into the integration methods by observing judgmental forecasts without an integration method before introducing the integration method. Additionally, the timeframe during which Applicants ran the field study was brief (between 20 and 30 weeks) and unique (beginning of the COVID-19 pandemic), including only a few negative adjustments. Given that humans adjust a small portion of forecasts, future studies could use more than 30 weeks to allow for more adjustments. Human-Guided Learning improves when there are more adjustments. Lastly, since Applicants' data is not a live implementation of Human-Guided Learning, Applicants cannot examine how forecasters would change their behavior if a firm implemented Human-Guided Learning as a forecasting process. Further research is required to determine forecaster behavior and its effect on Human-Guided Learning.

Applicants' study proposed a hierarchy of integration methods. Applicants expected Input to Model-Building to perform better than other adjustment methods. Applicants also believed that Integrative Judgment Learning would perform better than Input to Model-Building, and Human-Guided Learning would outperform Integrative Judgment Learning. Applicants' experiment only partially supported this hierarchy, but one contribution of Applicants' work is to highlight that Human-Guided Learning and Integrative Judgment Learning have clear advantages, in the lab and the field, compared to other integration methods. This finding emphasizes that firms can still benefit from human judgment in forecasting. Integrative Judgment Learning and Human-Guided Learning even outperform the sophisticated ML methods employed by Applicants' industry partner. Many firms still use Judgmental Adjustments; to Applicants' knowledge, few firms actively pursue Integrative Judgment Learning and Human-Guided Learning as forecast integration methods. Applicants hope that Applicants' work provides firms with an incentive to do so and researchers with an incentive to investigate these practical forecast integration approaches further.

Applicants' results suggest that asking employees to share their information with the model, rather than allowing them to adjust the forecast directly, can help eliminate human judgment biases. Another strength of Human-Guided Learning is the ability to codify information that otherwise resides only in the minds of individual forecasters. Human-Guided Learning enables the model to learn from the forecaster's experience continually. Firms implementing Human-Guided Learning need not replace the current system used for demand planning. Instead, Human-Guided Learning uses the system forecast as an integral part of the forecasting process and calculates the strength and weight of the private information. However, modifying the demand planning process would require well-designed change management to overcome resistance. The change management necessary for implementing Human-Guided Learning would need to focus on the model's ability to identify the weight and strength of the private information managers use to adjust the model rather than the loss of control to the managers. Additionally, when designing forecasting support systems (FSS), Applicants' results show the importance of using the correct method that employs the strengths of users and algorithms. Thus, to capture the value of private information outside the model, Applicants encourage practitioners to consider implementing Human-Guided Learning as it can potentially improve predictive performance.

In conclusion, Applicants' results suggest private information leveraged by humans can enhance forecasting accuracy. However, Applicants' research indicates that what matters most is using an appropriate process of integrating machine learning and human judgment. Applicants' results suggest that Integrative Judgment Learning and Human-Guided Learning are the most accurate methods of integrating model and human judgment forecasts. The field study identified that there might be circumstances when Human-Guided Learning outperforms Integrative Judgment Learning. Applicants encourage further research into defining the boundary conditions for when Human-Guided Learning is most accurate.

### Example 2. Unleashing the Power of Big Data in the Retail Supply Chain: The Partnership of Analytics and Managers

Analytics and artificial intelligence (AI) are fundamentally changing retail supply chains. Whereas analytics is being heralded for its automation of decision processes, these technological changes are ultimately impacting managerial roles and the process of integrating decision making. Applicants' research addresses these issues. First, using grounded theory, Applicants conduct in-depth interviews of 21 executives spanning the retail supply chain ecosystem, to glean the current real-world application of these technologies. Applicants' findings demonstrate that analytics is typically used to process large datasets and that human judgment is consistently used for interpretation and overrides. Human judgment plays an increasingly greater role moving up the retail supply chain, away from the customer. Second, Applicants identify elements of successful integration of managers with analytics when managers have knowledge not available to the model. Third, Applicants use these elements to develop a framework for a successful process of integration of people and technology. Fourth, Applicants identify the barriers to successful implementation of analytics systems due to managerial lack of trust in models, algorithms, and shared data. Applicants' research extends the extant research which calls for effective value creation of analytics via simultaneous attention to technology, people, and processes. Thus, Applicants' paper addresses this call and offers improvement for the integration and implementation processes of people and technologies within retail supply chains.

### Example 2.1. Introduction

The past decade has witnessed an explosion of data, analytics applications, and artificial intelligence (AI) available to companies and their supply chains. These technological changes are especially true for retail supply chains that have become heavily instrumented with sensors, tags, trackers, and other smart devices collecting data in real time and automating processes and transactions. Thus, analytics and AI are fundamentally changing the functionality of retail supply chains. A recent study by the McKinsey Global Institute documents the changes and finds that 52% of all activities in retail can be automated with current technologies. However, the McKinsey study highlights the role of humans working in tandem with technology as an element of retail supply chain functionality and new skills required by humans. The McKinsey finding is consistent with a rich body of research that repeatedly shows the important role of human judgment in decision making, well beyond that of provided algorithms.

Whereas analytics continues to be heralded for efficiency and precision, these technologies are ultimately changing the role played by humans, from workers to managers. The process of integrating human decision making with these technologies to optimize outcomes is useful, yet the integration continues to be one of the greatest challenges of digital supply chains. Past studies of actual technology use across organizations consistently show that people at all levels of the organization view technology as an adversary, often bypassing it or sabotaging it. These sabotage findings make the challenge of the human-technology interface of particular importance.

Applicants' research addresses the emergent question of the human-technology interface-what is the role of management in a digitized retail supply chain? Specifically, Applicants address three issues. First, Applicants present how these digital technologies are currently being used across retail supply chains. While previous studies typically show a lack of technological usage, past studies were all conducted pre-COVID-19. Applicants aim to assess technological usage pre and post COVID-19, as evidence suggests the pandemic has pushed many retail companies to rapidly move to digitization out of necessity. The pandemic has created unprecedented supply chain disruptions and assessing technological usage in what is seen as a new era of retail is useful. Second, Applicants identify elements of successful integration of managers with analytics, identifying those elements that contribute to success (e.g., managers knowledge of specific information) and those that are detrimental (e.g., unjustified and/or inappropriate overrides of algorithmic output). Third, Applicants use these elements to develop a framework that defines a successful process of integration of people and technology and offer specifics for framework implementation.

Using grounded theory, Applicants conducted in-depth interviews of 21 executives from companies spanning the retail supply chain ecosystem. Applicants reveal the state-of-the-art usage of these technologies by managers and their organizations, as well as the resulting changing role of managers as they work with these technologies. Applicants' findings document a significant implementation and acceptance of analytics and technology, marking a major departure from previous studies, with managers recognizing the benefits that technology offers and not seeing these advances as a threat. Applicants find that the pandemic shaped technological usage, as uncovered by comparing pre- and post-pandemic interviews. The pandemic effect is a novel finding. This COVID-19 finding also underscores that results from pre-pandemic studies may be less indicative of usage and attitudes toward technology after the pandemic shock.

Further, Applicants find that while analytics is used to process large data sets, human judgment is consistently used for interpretation and overrides, with human judgment appearing to play an increasingly greater role moving up the retail supply chain away from the customer. Interviews acknowledge that today's massive amount of data is overwhelming, creating information overload. Where technology is used to collect and synthesize data, humans supplement these connections with interpretation, insights, and explanations, facilitating useful communication of said data to invested parties. However, Applicants' findings suggest that moving up the supply chain, data becomes less abundant and human relationships and judgment become more important.

These findings are supported by past research that shows human judgment and analytics each have their unique strengths and weaknesses. Analytical algorithms based on big data have the advantage of being objective, consistent, powerful in processing large datasets, and can consider relationships between many variables. However, the output of these algorithms is only as good as the data upon which they are based, and the methods used. By contrast, humans have strong abilities in interpreting data sets of limited size. Humans have strengths in detecting non-trivial patterns, non-trivial trends, and interpreting these patterns and trends in light of rich sets of data points. These strengths include humans' awareness of context, experience, intuition, and domain-specific knowledge. Humans are also creative and capable of generating novel solutions to problems. However, humans do not have the same strengths that algorithms have. Humans can process only relatively small datasets, lack consistency, and often bring biases to the decision-making process. As such, humans and algorithms each have their unique strengths and weaknesses. As a result, the best strategy to extract intelligence from the vast amounts of data is to integrate them.

Applicants' findings are novel and contribute to the rich body of literature that shows combining human judgment with algorithms leads to improvements in decisions. Managers often have up-to-date knowledge of changes and events occurring in their environment that can affect outcomes. Through the process of integrating human judgment with analytics, this “soft” information can be incorporated. For example, managers may become aware of rumors of a competitor launching a promotion, a planned consolidation between competitors, or a sudden shift in consumer preferences due to changes in technology. Human judgment can be used to override algorithms to rapidly incorporate this information. There are, however, caveats to these findings, such as human judgment acting in the presence of specific contextual information. Applicants identify these caveats, then use them as the framework foundation for integrating people and technology across the retail supply chain.

Applicants' research extends the extant research which calls for effective value creation of analytics through simultaneous attention to technology, people, and processes. The focus of this research addresses this call with findings that expand research and contribute to practice by improving the process of integration of people in retail supply chains with changing technologies.

### Example 2.2. Methodology

This section details the methods used to understand how retail supply chain managers use analytics and AI. Applicants also develop a framework based upon these practices to serve as a guide for both researchers and practitioners. In order to develop a comprehensive, in-depth understanding of these practices, Applicants employ a grounded theory approach best suited for this type of research. Grounded theory allows for a deeper elaboration on individual behavior and organizational dynamics following well-established protocols. This theoretical approach also provides a rigorous, systematic process to develop and explain the topic as experienced by the participants in the study.

Context and Sampling Criteria. The phenomena Applicants are studying is experienced by individuals at all levels of a firm and multiple echelons across the retail supply chain ecosystem. Following standard procedure, Applicants employed purposeful sampling. Purposeful sampling allows the researcher to select individuals and sites for study because they can purposefully inform an understanding of the phenomenon in the study. In grounded theory, the researcher purposefully starts with individuals and firms who can contribute to the development of theory. Grounded theory researchers typically start with a homogenous sample of individuals who have commonly experienced the action or process. This method allows the researcher to focus, reduce, simplify, and facilitate group interviewing.

In order to ensure maximum variation, Applicants split Applicants' sampling criteria into two categories. First, Applicants determined complete job titles of individuals who are experiencing the phenomena. Applicants identified and categorized titles ranging from analyst to executive. A part of selecting the individual was whether they had a role in the retail supply chain. Second, Applicants identified the echelons in the retail supply chain by appealing to existing literature. The echelons Applicants focused on include: manufacturer, supplier, service provider, transportation (3PLs) and retailer.

Following the identification of job titles and echelons, Applicants partnered with the Supply Chain Management Research Center (SCMRC) at the Walton College of Business at the University of Arkansas. Through close collaboration with the SCMRC, Applicants followed a bipartite approach at recruiting participants. Applicants conjointly contacted individuals in the roles Applicants identified at firms that fit the echelons of the retail supply chain and firms that fit the echelons of the retail supply chain to see if they would connect us with individuals.

Applicants' final sample consists of 21 in-depth interviews with individuals from 13 firms. The positions ranged from Operations Analyst to Chief Executive Officer (see Table 10 for details on the sample).

TABLE 10
Research Participants and Firm Demographics

| | | | Annual |
|---|---|---|---|
| | | Echelon in retail supply | sales |
| Job title | Area of focus | chain | revenue |
| Director | Transportation | Manufacturer | 1-50 B |
| Associate Director | Network Strategy | Manufacturer | 1-50 B |
| Analyst | Human Relations | Manufacturer | 1-50 B |
| Director | Customer Logistics | Supplier (CPG) | 50-100 B |
| Director | Customer Supply Chain | Supplier (CPG) | 1-50 B |
| Senior Director | Supply Chain | Supplier (CPG) | 50-100 B |
| Senior Manager | Supply Chain | Supplier (CPG) | 1-50 B |
| | | Supplier (Home and | 1-50 B |
| Analyst | Operations | Garden) | |
| | | Supplier (Home and | 1-50 B |
| Senior Director | Sales | Garden) | |
| Senior Business | | | |
| Analyst | Supply Chain | Supplier (Seafood) | 5-25M |
| Senior Director | Logistics | Supplier (Seafood) | 5-25M |
| Chief Executive Officer | | Service provider | 5-25M |
| Senior Director | Operations | Service provider | 1-50 B |
| | Supply Chain | | |
| Vice President | Replenishment | Service provider | — |
| | | Third-party logistics | 1-50 B |
| Director | Operations | provider | |
| | | Third-party logistics | 1-50 B |
| Director | Operations | provider | |
| | | Third-party logistics | 1-50 B |
| General Manager | Operations | provider | |
| | | Third-party logistics | 1-50 B |
| General Manager | Operations | provider | |
| | | Third-party logistics | 1-50 B |
| General Manager | Operations | provider | |
| | | Third-party logistics | 1-50 B |
| Senior Vice President | Operations | provider | |
| Director | Data Scientist | Retailer | 100 B+ |

The firms can be classified into five echelons: manufacturer (2), supplier (6), service provider (3), third-party logistics provider (1), and retailer (1). The suppliers vary across three segments: consumer-packaged goods (CPG), home and garden, and seafood. The diversity of the sample allows for a holistic view of the use of analytics throughout the retail supply chain ecosystem. As outlined by prior literature, Applicants concluded Applicants' sampling upon reaching theoretical saturation. Since the determination of theoretical saturation is guided by the iteration of interviews and analysis, Applicants will discuss this in greater detail in the Data Analysis section.

Data Collection. Applicants carefully followed the data collection protocols described in literature to ensure rigor. Data was collected via semi-structured interviews ranging 45-60 minutes. The interviews were conducted either in-person or on Zoom. The recordings were transcribed using Otter.ai. The transcripts were then reviewed (and revised) by a trained research assistant to ensure the transcription accurately reflected the exact language, and tone, of the participant. Additionally, the research team took notes during the interviews and created theoretical memos directly after the interviews.

Prior to the scheduled interview, the participants received a guide of what to expect. The guide indicated the interview would be recorded, promised anonymity to the participants, and provided a brief overview of the context of the research question.

The interviews were conducted over the course of 20 months (October 2019-May 2021). The length of the data collection period is not unusual for grounded theory since the iterative comparison between interviews and analysis takes time. Interestingly, the COVID-19 pandemic started in the middle of Applicants' data collection. As such, Applicants' data offers the unique perspective of individuals' behavior prior to and after the start of the pandemic. Due to the iterative nature of grounded theory, the pandemic helped shape the questions in Applicants' later interviews.

The first several interviews were guided by semi-structured questions aimed at obtaining “both retrospective and real-time accounts by those people experiencing the phenomenon of theoretical interest”. Since Applicants' method is inductive research (i.e., Applicants are interested in the participants' experience, rather than confirming existing concepts), the questions were carefully developed to avoid leading questions. Examples of the initial semi-structured questions include: “Have you worked with analytics?,” “Describe the decision-making process (and tools you use),” “How do you interact with software or statistical models?,” “Where do you go to find information regarding trends (e.g., public press, etc.)?,” and “Do you have any pressure from upper management to change your behavior or incorporate more technology?”

The semi-structured questions were then iteratively adjusted as guided by the insights from previous interviews. While reviewing the previous interviews, Applicants asked both action and analytic questions to identify emerging theoretical categories and concepts. Interestingly, although the COVID-19 pandemic was a significant disruption to retail supply chains, Applicants' research question regarding the interaction between humans and analytics remained an area of inquiry pre- and post-pandemic start. Applicants discuss this intertemporal effect in the Discussion section.

The cyclical process of adjusting the interview questions continued until consistency and representativeness of theoretical categories emerged. During the last five interviews, the theoretical categories remained consistent with those that emerged from the previous interviews. Therefore, Applicants concluded an adequate representation at 21 interviews upon achieving theoretical saturation.

Data Analysis. Corbin and Strauss provide an in-depth overview of procedures and canons of grounded theory research. Other researchers have built on their methods and provide details in how to obtain rigor in qualitative analyses. Applicants adhere to an analysis method that differs from previous grounded theory approaches by creating a data structure. The data structure allows for a visual representation of the systematic coding process, thus meeting a key component of establishing qualitative rigor. The first step in the method is coding 1^{st} order concepts.

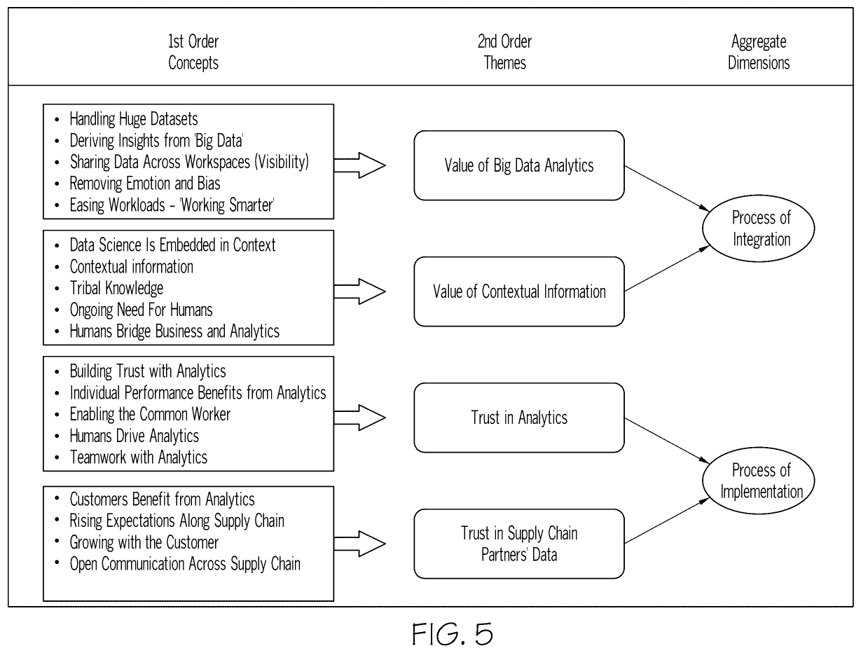

The coding of the 1^{st} order concepts was performed independently by the research team using NVivo (Release 1). NVivo allows the transcripts to be imported as raw data. The researcher is then able to create “nodes” for emerging categories and sub-categories using terms and phrases. The initial 1^{st} order coding resulted in 168 categories and subcategories between the research team. The research team then met to discuss the similarities and differences in the categories and subcategories with the goal of achieving a consensus. The research team discussed 42 categories and subcategories. Following the meeting, the categories and subcategories were collapsed into 19 1^{st} order concepts (see FIG. 5).

Next, the research team evaluated the 1^{st} order concepts with the goal of identifying 2^{nd} order themes, dimensions, and narratives. Throughout the iterative process of interviewing and analyzing the data, these themes provided guidance for subsequent interviews. Over the course of the interviews, the 2^{nd} order themes provided a nuanced view at individuals' use of and attitude toward analytics and AI in retail supply chains. The four 2^{nd} order themes were consistently present in the participants responses (see FIG. 5).

Lastly, the full entrance into the “theoretical realm” by abstracted to aggregate dimensions. The aggregate dimensions act as “core categories” that provide an overarching view of the central phenomena in the research. The aggregate dimensions that emerged from Applicants' interviews offer specific insight into the two crucial components to capture the value of analytics in retail supply chains (see FIG. 5).

The main purposes of constructing a data structure such as FIG. 5 are to visually see the process of turning raw data into themes and spur the researchers into thinking about the data theoretically. At this stage, Applicants transition from the inductive portion of grounded theory to the abductive portion by circling through the emergent 2^{nd} order themes and existing literature to provide further “theoretical reach”.

As researchers, Applicants acknowledge Applicants' prior experiences and training leave us prone to biases. Therefore, to ensure the “voice of the respondent” is prominently represented, Applicants enlisted the assistance of two trained research assistants in addition to the research team. The research assistants assumed the role of an “outsider perspective”.

### Example 2.3. Findings

Applicants' overarching research question guiding the interviews was: What is the role of the manager in a digitized retail supply chain? The four themes that emerged from the 1^{st} order concepts and existing literature for retail supply chains are: 1) value of big data analytics, 2) value of contextual information, 3) trust in analytics, and 4) trust in supply chain partners' data. These four themes can be abstracted into two overarching dimensions related to analytics use in retail supply chains: the process of integration and the process of implementation.

Process of Integration. One of the two aggregate dimensions that emerges from Applicants' research is the process of integration of analytics with human judgment. While firms are implementing analytics model-based or AI-based systems to take advantage of available big data they are continuing to rely on inputs from managers. According to retail supply chain executives, the reliance on both analytics and managers stems from the acknowledgement that the strengths of each are complementary. It is the process of integration that is seen as one of the key aggregate dimensions of bringing value to supply chain analytics, rather than analytics alone.

Value of big data analytics. Participants from all echelons frequently mentioned the volume, variety, and velocity of data available in retail supply chains. The sheer amount of data resulted in many participants being quick to admit their limitations in analyzing and processing the vast quantity of data. A Senior Sales Director at a CPG supplier stated:
“There's so many different things that happen at shelf you do need a lot more systems and technology to help guide what that might look like . . . no human can manage a million items or combinations.”
   Similarly, a Senior Vice President of Operations at a 3PL acknowledged:
“Humans could never do this; there's just too many different scenarios. Over 70 million opportunities a day.”
   In fact, all the participants accepted that algorithms are better than human judgment at many functions in the retail supply chain and can be used to ease participants' own workload.

The strengths of analytics-based systems lie in the processing power, identification of systematic variability, and visibility. A Director of Data Science at a retailer explained that the processing power of analytics systems has increased exponentially with the explosion of data. Operations, such as running deep neural networks, that previously took large amounts of time are now much easier. Additionally, where humans are prone to biases and emotions, algorithms excel at identifying systematic variability. As explained by a Senior Director at a service provider:
“The technology can actually detect trends, causals, and events sooner than [the managers] can . . . it's night and day difference.”

Lastly, participants noted analytics provides an improved level of visibility into all echelons of the retail supply chain. Much of the large quantities of data that are available to firms often come from upstream and downstream members of the retail supply chain. As the Director of Operations at a 3PL put it:
“We have lots of data. From customers, from carriers, from internal groups, I mean there's a large amount.”
   A Senior Business Analyst at a home and garden supplier detailed:
“The early 2000s were characterized by a genesis of the ability to collect data. Suddenly, all industries could record everything. They could record everything that everyone was doing, everything their product was doing, they could transfer it across the country to [collaborators], they could store it in big data warehouses, and they had years and years of granular data. And so now, We have all of this information on our fingertips.”

The interviews reveal the theme of the tremendous value analytics brings. Data by itself is often useless. Rather it is the analytics that can extract information out of the that data. However, despite the excitement expressed by the participants surrounding analytics and AI, the interviews also reveal specific instances when managers compensate for the shortcomings of big data. One theme was repeated in every interview: Managers remain a crucial part of the retail supply chain. Therefore, while analytics provides value, by itself it is not enough. To achieve the value made possible by analytics, managers must provide context. Applicants discuss context next.

Value of contextual information. The retail supply chain ecosystem is becoming increasingly dependent on data analytics, but managerial judgment continues to provide the context in which the analytics is embedded. Analytics and AI are only as good as their inputs. Oftentimes, due to the complexity of retail supply chains, such as special events and new items, the historical data is not sufficient to predict the future. Special events that occur outside of the data available to the analytics would be excluded from the analytics if not for managers—these scenarios are where the value of contextual information available to humans (e.g., tribal knowledge) is useful. Applicants' data uniquely captures the attitude towards managers' use of contextual information prior to- and during the massive disruption of COVID-19.

Interviews prior to the COVID-19 pandemic focused on using analytics to automate operations while allowing managers to intervene during special events. A Senior Vice President of a service provider elaborated on the tensions from managers associated with automation:
“If my role is defined as a forecast analyst, my accountability is forecast accuracy. If I'm heavily leveraging AI and machine learning to [forecast] without my input, but the outcome is bad, I'm still accountable . . . . What does accountability without touchability create? Frustration.”
   The Senior Vice President continued to explain automation is useful, it frees up managerial time, but accountability and touchability need to be carefully aligned. Similarly, a General Manager of Operations at a 3PL pointed out special events are inevitable saying:
“You want to automate, you want to be efficient, but there's still elements of an individual's discernment that you can't necessarily capture through AI.”
   Several months after the first peak of COVID-19, participants demonstrated how the pandemic exposed the vulnerability of digitized retail supply chains. Interviews focused on improving flexibility and adaptability, which largely relies on managers' recognition and interpretation of abnormal changes to demand. A Senior Director of Supply Chain at a CPG supplier explained
“I'll give an example with the pandemic. Before we were always trying to achieve 98.5%, 99% in-stock and in this pandemic environment, sometimes, some of our categories and some our products are struggling to get to 70 to 80%, which is a huge gap. So [managers] are really focused on fixing that issue.”

Improving the in-stock KPI often depends on identifying the context around anomalies in demand patterns. For example, a Senior Director of Supply Chain at a CPG supplier indicated:
“The pandemic's changed the demand patterns on a lot of these staple items. [Now] we're back to normal run rate from a pattern standpoint, so you find these types of models to be very accurate. Except the anomalies. [Humans are needed for] the ones that are highly seasonal, highly promoted. You know, promotions at [the retailer] could just be end caps, so putting product at the end of an aisle or in a freezer space that's in the end of the freezer section, really drives a lot of demand. That's where you need a human to say . . . the retailer is running a [surprise] promotion that will change demand for those types of items.”
   Another example is provided by a Senior Director of Logistics for a seafood supplier:
“I do believe computers can be smarter than people . . . they're going to win out more often. But I think you are always going to have to have a person involved that has their ear to the ground because [the buyers representing the retailers] are still humans . . . a lot of the decision making for buyers is not just purely numbers; it is emotional.”

Many of the participants noted at the height of COVID-19 prior to vaccines (April-August 2020), the analytical systems were completely thrown out and managers were relying solely on managers' use of contextual information. The Senior Director of Logistics for a seafood supplier bluntly shared:
“We were using this system when COVID happened, and [as the pandemic continued] we said forget what the system is saying.”

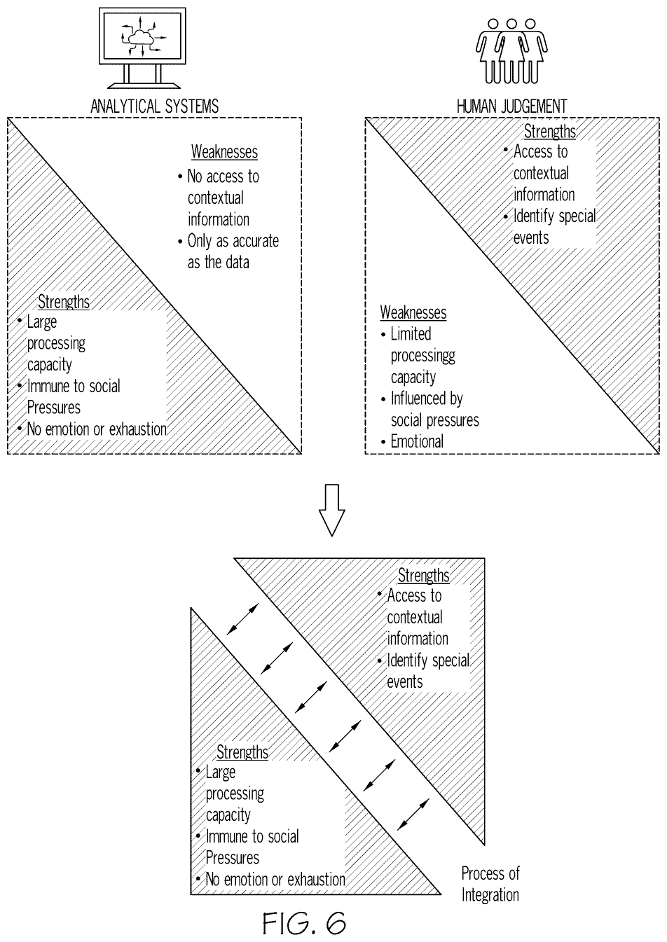

COVID-19 certainly solidified the need for managers to provide contextual information to the analytical-based systems as part of the decision-making process. However, existing literature reveals there are several ways to integrate managers' use of contextual information and analytics. Therefore, in Applicants' later interviews, many of Applicants' questions were designed to dig into best practices for the process of integration. FIG. 6 illustrates the logic behind utilizing a process of integration.

In summary, the interviews reveal the ideal process of integration would allow managers to provide inputs to train the analytical system. As a Director of Customer Logistics at a CPG supplier stated:
“Humans play a very important role in helping bring context to the varying degrees of inputs that can go into the model . . . we need these humans to come and meet and validate the data and put their own insights that the system doesn't [have]. They have knowledge of [disruptions] and context.”
   A Chief Executive Officer of a service provider provided an example of a desirable process of integration:
“[With] the Suez Canal [blockage], there's no way for us to have loaded in that Black Swan event into our model. But since we have humans to correct and feed in information [to the model] about the world, the computer can make those predictions. So, we need a way for humans to provide information to the model.”
   Additionally, a Senior Director of a CPG supplier indicated:
“[Managers] see a good statistical model driving accuracy [in some items], and then the other [items] you're looking at this is not very accurate. [The model] results in well below average for an item. A lot of our biases are driven off of time series, historical patterns. So, [the manager] asks where's history not repeating itself? And what are the business reasons why history is not repeating itself? So, that's where the humans go out and actually understand and quantify some of those drivers and put them back in the model.”

Therefore, an effective process of integration should ensure the contextual information from managers is incorporated into the data used to train the analytics and AI, not used as a one-time adjustment.

Process of Implementation. The second aggregate dimension emerges from Applicants' study regarding use of analytics across retail supply chains. It is the process of implementation. While theoretically the integration of analytics with managerial judgment makes sense given their complementary strengths and weaknesses, there are challenges in the actual implementation. Existing literature has often discussed the most difficult part of adopting analytics is the distrust of these technologies by managers. Recall that past studies reveal that possible value creation of analytics is frequently diminished by managers' overrides and adjustments, as well as sabotage of the system. Interestingly, Applicants' study shows that attitudes of managers have changed significantly over the past few years. Managers are now more trusting of the use of analytics, especially managers situated in further downstream echelons. Trusting and accepting are important elements of implementation, as discussed next.

Trust in Analytics. Every interview Applicants conducted mentioned a general shift in attitude toward managers' viewing analytics as a powerful tool that enhances their performance. A Senior Business Analyst for a home and garden supplier compared analytics to a hand tool:
“[Analytics] is just a really, really fancy pickaxe. It's something that we have made to do a job. [Analytics] sound pretty, but it's not gonna do our jobs for us. It's not going to generate unique inspiration . . . computers do not become inspired; they simply do math.”
   A Director of Data Science for a retailer used a similar analogy:
“[Analytics and AI] are not replacing humans. [They're] simply better tools to help you do your job better.”
   By viewing analytics as an enabler, managers switch the fear of being replaced for excitement and drive to partner with analytics. Ultimately, participants suggested they completed their tasks more efficiently by using teamwork with analytics. A Senior Director of Supply Chain at a CPG supplier detailed the role of trust in using analytics:
“AI and machine learning are a bit more of a black box, albeit they're showing promise of how much more accurate some of those models are . . . [managers] are like, okay that's an input, I don't necessarily need to worry about explaining that as much as I need to have faith and trust it.”

A major benefit of trusting analytics that emerged from the interviews is that viewing analytics as a partner allows managers to admit their weaknesses in a positive way. For example, a Director of Customer Logistics at a CPG supplier conceded:
“People frequently put a positive bias on forecast, right?I think generally, we're optimistic. Generally, we're aspirational. Everybody wants to generate more revenue, more profit, and there's pressure to do that. So, I think what we see is a tendency to put positive bias on forecasts, and I think that's one thing that removing the human dimension can allow for is a more accurate forecast.”
   The emotion and pressure present in managers is not inherently a bad thing; however, these factors can lead to biased decisions. Since participants are more comfortable accepting and trusting in analytics, participants are also recognizing where they contribute and where they interfere in overall performance.

Retail supply chain ecosystems are inherently comprised of complex relationships. Prior literature on retail supply chains has studied the relationship dynamics related to multi-echelon inventory management, time pressure, and many other phenomena. Applicants' data revealed a novel perspective that has yet to be addressed in the literature—the reliance on human judgment across varying echelons.

Trust in Supply Chain Partners' Data. Employing analytics and AI offers further insights into B2B relationships. An Associate Director of Network Strategy at a manufacturer remarked:
“You know, it's, funny. You talk about analytics, and you think it's a pure data world. But really, relationships are what start tipping that scale [of value creation].”
   Collaboration across the retail supply chain provides visibility and access to increased information regarding past and future events. Participants revealed that open communication across the supply chain greatly enhanced their use of analytics. Participants also revealed varying levels of trust in supply chain partners' data. A Senior Director of Logistics at a seafood supplier remarked on the differing levels of trust with their customers:
We get a lot of that data directly from our customers. Our first customer has [a system where they] offer data for free, which is really excellent because not all of our customers do that. The data that we get from retailing is only [our company's] sales. We don't use what the retailer is ordering from us in the equation [for demand planning], We use what they're actually selling because we understand that long term, they don't want to just keep building inventory. If [the retailer] orders really heavy, eventually they're going to slow down and they're going to reduce to the point where they're ordering what they're, selling. [At that point] we're going to be pointing out to them, “hey, you just ordered six weeks of supply two weeks in a row. That's a problem for us and you're not selling that, what's going on? So there's definitely like a level of trust that has to go into that [relationship with the retailer].
   Further upstream, A Director of Transportation for a manufacturer remarked on the lack of trust with their supply chain partners:
We ship two million-ish packages in the US every year through one of our partners. I mean it's a lot, and the data from [our partner] is horrendous. First of all, they don't readily share data, and they don't have a good platform to get the information from. So we're heavily reliant on freight payment data which takes a long time to get it all in . . . . I joke all the time that [our partner] is just a bunch of criminals: the way they bill, the way they charge you. Our contract is 57 pages, or something crazy like that. And so, just trying to make heads or tails of what they're charging you and how to do the cost management is incredibly difficult . . . we couldn't get to shipment count, we couldn't get to actual weight because they have actual weight, build weight, and dimensional weight. It's just all this smoke and mirrors that they do to try and charge you a lot of money.
   Another interesting insight revealed from the interviews is that not all echelons regarded the use of contextual information equally.

The interviews reveal a nuanced effect that the value of human judgment may sometimes depend on the echelon of the retail supply chain. A Senior Director of Sales for a home and garden supplier explained:
“The item-store forecast for a widget is driven through an AI that has multiple inputs related to whether sales consumption differ in three or four other inputs. [The retailer's analytics] are continuing to work toward what the consumer is doing. The closest [echelon] to the consumer is going to likely get more help from technology and artificial intelligence. There will be more human decision-making as you revert backwards from that.”
   Upon conducting this interview, Applicants reviewed the previous interviews to see how varying echelons described the use of their analytics. Interestingly, the further upstream the retail supply chain (manufacturers and suppliers), the greater the reliance on managerial judgment. A Director of Transportation at a manufacturer recounted:
“When I was hired at [the manufacturer], I felt like I stepped into the dark ages. I mean they didn't have a TMS, they didn't have carrier integration, everything was manual. we are just now today implementing carrier integration, and a TMS. Honestly, it's embarrassing right? It's like everybody else did this twenty years ago. It took me three years into the director role, before I could finally be like ‘we have to do this, come on.’”

In contrast, the participant at the retailer spoke candidly regarding their use of sophisticated analytics and AI. The retailer uses a massive data lake to train machine learning systems with thousands of features. The data lake is comprised of information ranging from suppliers to the consumers.

In summary, the process of implementation is a component of capturing the value creation of analytics in retail supply chains. Applicants find collaboration between echelons allows for more efficient use of analytics. Perhaps most importantly, contextual information currently seems to be relied on most in the upper echelons of manufacturers and suppliers.

### Example 2.4. Discussion

The overarching goal of Applicants' research was to provide a framework that helps explicate the major factors that underlie successful deployment of technology-enabled analytics (i.e., the role of managers) to create value in the retail supply chain. Prior research has established a framework for establishing digital supply chains that encompasses digital awareness (the strategic view of executive leadership), digital ecosystem (the interactions of supply chain organizational entities within a seamless enterprise), and digital transformation (a blueprint governing the integration of various supply chain activities). Complementing this framework Applicants' research provides a granular view of how retail supply chains may take full advantage of the potential enabled by automated systems. In retail supply chains in particular, people remain at the heart of business processes. Human importance is despite the proliferation of technology-enabled data sources, and ubiquitous and pervasive technologies such as mobile apps that allow for real-time deployment in every location in the supply chain, from lower-tier suppliers all the way to customers who receive home delivery, and thus incorporated into the end of the supply chain.

The two dimensions (the process of integration and the process of implementation) that emerged from Applicants' analysis provide greater insight into the value creation of analytics in retail supply chains and lead us to offer two propositions.

It is evident that managerial judgment is an integral part of decision making in supply chain processes even with the advent of automated analytics-based systems. One of the most striking emerging themes from Applicants' interviews was that bringing together managerial judgment and system-based recommendations is a complex exercise fraught with difficulties and potential pitfalls. Applicants identified consistent views on the advantages of automated systems and why such systems were necessary for the functioning of a modern retail supply chain. Applicants also identified surprisingly consistent views about the need for managerial judgment, although there were caveats about the shortcomings of human decision-making capabilities and reservations about the efficacy of managers' use of the systems. It was evident that the capabilities of automated systems mirrored the frailties of managerial judgment and decision making. It was also evident that the most compelling reason why managerial input and judgment were necessary, was because of their ability to do something that automated systems could not—to bring in subjective judgment and information about events that were not available to the sensing mechanisms and data feeds in the automated system. Applicants propose that processes should be designed so as to go beyond the capabilities of model-based analytics systems which are usually used by managers as a source of information before they override the system by making a judgmental adjustment. The process could instead take advantage of the relative strengths of AI algorithm-based systems as well as the abilities of managers.

A simple AI system could incorporate a machine-learning algorithm that could learn from manager input over time, identifying and correcting for bias in that input. Such processes would allow systems to incorporate and process all the considerable available data from many sources, and to also systematically incorporate managers' input as an additional source of information-thus circumventing biases and inaccuracies in manager judgment and decision making.
Proposition 1: The most effective process of integration utilizes contextual information from managers to train an AI-based system.

Applicants' research reveals that a major barrier to the effective deployment of automated systems is that managers override the system when it is inappropriate to do so. As Applicants previously explained, allowing the system to incorporate managerial input is important for performance. However, there are numerous reasons why managers may make inappropriate adjustments. One is that they may not trust algorithms, especially if they do not know how the algorithm works. Prior research has shown that people display algorithm-aversion, and that one remedy is to make transparent the functionality of the algorithms used in the system. Another reason that managers may avoid using system recommendations is because management may not trust information from partner firms. While collaboration in the supply chain is known to promote supply chain efficiency, there are perverse incentives for managers in partner firms to engage in opportunistic and non-cooperative behavior by misreporting information that hinders collaboration between their firms, which can result in reduced efficiency. Furthermore, there is evidence that when agents in partner firms anticipate non-cooperative behavior by their counterparts, they engage in non-cooperative behavior as well. Since data that is used by automated systems includes data from partner firms in the supply chain, an erosion of trust in shared information leads to an erosion of trust in the system, and therefore a reason to override the system. Finally, regardless of whether or not managers trust the system, they may not know the type of contextual information they may have that constitutes an appropriate reason for them to override the system. For these reasons Applicants propose that firms need to incorporate transparency in the design of their system user-interface, institute trust building mechanisms between firms, and design training interventions into their change management as they implement automated systems.
Proposition 2: The process of implementing automated analytics systems should incorporate manager attitude and beliefs by building trust in algorithms and models, instilling trust in shared information from partner firms in the retail supply chain, and training managers to recognize when it is appropriate to override the system.

In summary, the framework based on responses from the participants in Applicants' research incorporates people at the heart of supply chain decision-making even when sophisticated automated systems are available. Managers provide valuable input to an analytics or AI-centric system to provide additional demand visibility and supply visibility. The biases and inaccuracies inherent in input from managers needs to be accounted for and corrected as a part of the process of integrating that input into decision making. Managers need to be trained to use automated systems to attain decision making efficiency, and they also need to understand and trust the models and algorithms that comprise the functionality of automated systems. Managers should trust the data whether from their own firm or shared data from other firms—it is the foundation for an automated system and a data-driven approach to decision making.

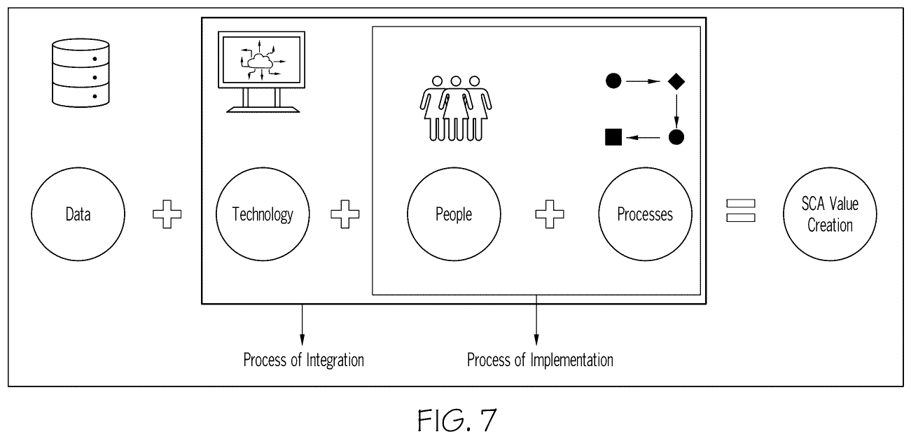

Data from automated sensing sources from enterprise-wide systems, from partner firms up and down the supply chain, is the first layer that results from demand and supply visibility. To make the best use of that automated data, further input from managers needs to be integrated in a carefully designed process that recognizes the potential value of both the automated data and the human input and then transforms the data into usable information. Firms also should recognize that when managers are involved, the implementation of new systems and processes should take into account the human trait of resistance to change. The framework visually represented in FIG. 7 demonstrates the role of people at the confluence of the processes of integration and implementation.

Contributions to Research. Applicants' research contributes to three primary research streams. First, Applicants provide a framework for value creation when deploying automated analytics-based systems in the retail supply chain. Prior research has addressed the strategic considerations that arise when digitizing the supply chain. Prior research has also identified demand visibility and supply visibility as the primary organizational factors necessary for analytics capability, and organizational flexibility as a complementary capability. Applicants' research enhances this stream by identifying key considerations for effective deployment of the system. In particular, Applicants highlight the role of the manager as integral for deployment of automated systems.

Second, Applicants contribute to the literature on forecasting and analytics that has studied the integration of human judgment and model-based analytics in two ways. Applicants provide evidence from the field that the problem in the retail industry of how to integrate remains an issue that is exacerbated and not ameliorated by the recent proliferation of evermore sophisticated model-based and AI-based systems. Especially in the era of the COVID-19 pandemic, Applicants have seen an acceleration in the adoption of digital technologies, but Applicants have also seen a heightening of the need for human intervention because of the unprecedented situational circumstances in which the retail industry operates. Applicants' research provides an in-depth view of the current state of affairs which is very different from a few years ago. Based on Applicants' interviews Applicants also characterize the capabilities and importance of managerial judgment and the capabilities of analytics systems. Based on this characterization Applicants introduce two new methods of integration that Applicants expect to be an improvement over existing methods of integration in the literature.

Third, Applicants contribute to the literature on process change. It is well known that resistance to change by managers can hinder the adoption and use of systems. Applicants identify from Applicants' interviews, several different reasons why managers may hinder the effective deployment of automated systems in the retail supply chain. These reasons in combination are unique to the context of retail supply chains, arising from the numerous sources of uncertainty regarding both demand and supply, the sheer volume and complex interrelated nature of the data from different sources, and the necessary reliance of data from partner firms. This combination defines a new context for the literature on process change and therefore Applicants provide the “what” factors and “why” related to the implementation of automated systems that researchers may use to provide a theory of context.

Contributions to Practice. Applicants make two important contributions to practice, as articulated in Applicants' two propositions. First, firms in the retail supply chain cannot merely introduce an automated system either as a decision-making entity or as an input into a human decision-making process. The majority of firms are known to use a judgmental adjustment process in which managers have available a system recommendation but have autonomy to override the system. Applicants' recommendation from Applicants' interviews as well as from prior research is that a more carefully designed process would use simple AI techniques such as human-guided machine learning or interactive machine learning in order to integrate model computations and human input. Second, Applicants find that there are multiple reasons why managers may not use systems that have been adopted at the enterprise level—and that it behooves firms to understand these multiple reasons and design system interfaces, to provide training programs, and to provide incentives and motivations for managers to use the system. The academic literature also shows that adopting new systems can be detrimental to employee outcomes including job performance, job satisfaction, job anxiety, and job security, These negative outcomes however can be ameliorated with interventions such as interface design that creates transparency into the algorithm function, user participation, training, and peer support.

Limitations and Future Research. As with all research Applicants' work has limitations and therefore provides opportunity for future researchers to investigate the extent to which the findings Applicants report apply in more general settings. First, Applicants designed Applicants' study such that all the participants Applicants interview are from firms in retail supply chains. It is possible that firms in other types of supply chains may be subject to different decision-making parameters. In certain industries that are less subject to the vagaries of event-based uncertainty, it is possible that purely automated systems without human touch may be effective. Future researchers should investigate supply chains other than those that are primarily retail. Second, Applicants' propositions are just that-propositions based on Applicants' grounded theory study that can be further empirically tested. Future research could conduct laboratory, observational studies, case studies, and field experiments at both the individual and the organizational level to determine the extent to which novel AI-based techniques can be developed to integrate managerial judgment and automated model-based systems. Third, whereas Applicants point to the need for carefully designed interventions that will be applicable to the unique context of the deployment of automated systems in the retail supply chain, Applicants do not provide details of the precise interventions that will be effective in this context. Future research could design and test such interventions that take into account the three characteristics of retail supply chains: (1) managers' trust in models and algorithms capable of processing data from a variety of sources of uncertainty related to both demand and supply, (2) managers' trust in shared information from partner firms that have their own profit-maximizing interests despite the common interest in an efficient supply chain, and (3) manager's knowledge of what types of private and subjective information should drive them to provide input to the system, and when managers should not intervene and change model recommendations.

### Example 2.5. Conclusion

Firms in the ecosystem of the retail supply chain have recognized the potential of deploying automated systems capable of processing the vast quantities of data available from multiple sources in real time. Paradoxically, the deployment of such systems has not eliminated humans from automated systems-firms need to incorporate human factors both as an integral component of the system and as a vital element of effective implementation.

### Example 3. Collaborative Human-Machine Learning for Demand Planning: Reimagining the Partnership Between People and Automated Systems

Prior research has shown that firms must understand how humans interact with machine learning systems to implement them successfully. The economic institution is crucial in facilitating human-machine partnerships; however, many implementations fail to consider the institution. In fact, most implementations replace existing tools with machine learning tools and leave the institution the same, which can lead to suboptimal results. Applicants' research introduces Collaborative Human-Machine Learning (CHML), a new institution that leverages the strengths of humans and algorithms to overcome their limitations. The process is derived from identifying elements of learning systems in prior literature and theory on machine learning, behavioral economics, and human-algorithm interactions. Using a large-scale dataset with 1.9 million observations encompassing 121 products in 10 categories over approximately 66 weeks, Applicants demonstrate that CHML outperforms both the ensemble machine-learning system used by the firm by 19.7% as well as the most common institution used in practice, judgmental adjustment by 21.1%.

### Example 3.1. Introduction

Artificial intelligence (AI) is proliferating as firms re-engineer business processes to take advantage of new technology, and supply chains, in particular, seek to adopt AI for planning activities. A recent survey found that 80% of supply chain leaders either plan to or are currently using AI and machine learning (ML) in planning. However, ML systems that enable AI processes pose unique challenges that have inhibited widespread proliferation in the supply chain. It has been reported 73% of surveyed supply chain leaders indicate that spreadsheets remain the top method for planning. Additionally, while implementing ML systems produces machine forecasts that may or may not improve performance over previous generations of analytics tools, the planning process usually remains the same. There is a view that the value added from the ML system may be dampened if the planning process does not change. Applicants' research presents a novel approach that takes advantage of the unique characteristics of machine learning tools and the human managers that use them to fully extract the potential benefits from the new technology and offset limitations. This approach provides a unique example of how best to achieve agency reversal in demand planning. Analytics takes on a more central role than the traditional approach in practice, in which analytics informs human decision-makers.

The academic literature on forecasting with ML systems has primarily focused on two main approaches, which Applicants broadly characterize as follows: (1) ML system makes the final decision, with little to no human intervention, or (2) human forecasters who have access to the output or recommendations from the ML system have the autonomy to make the final decision. Both approaches have a significant body of research documenting best practices. The evidence from practitioners suggests that while machine learning techniques are usually considered purely technological tools, practical implementation involves integrating the technological tools with human judgment, and only some technological tools operate autonomously. Researchers who have studied the integration of machines and humans have focused on changing human behavior to improve performance. To complement these approaches, Applicants argue that a third approach, collaborative human-machine learning (CHML), can be more effective than the two approaches seen in the literature. Applicants' research questions are: What elements allow for the most advantageous collaboration between human-machine learning? Moreover, does CHML improve the performance of human-machine partnerships?

Applicants identify five elements necessary for a forecasting process to enhance predictive performance based on examining the behavioral operations, machine learning, and time series literature streams. Applicants test the efficacy of the elements in Applicants' proposed process for improving performance using a large-scale proprietary dataset from a multinational retailer that uses ensemble ML algorithms in its forecasting process. The results suggest that all five elements provide significantly improved predictive performance. The results also offer evidence that CHML is more accurate than the ensemble ML methods used by the firm (absent of human intervention) and the current institution (judgmental adjustment, i.e., human adjustment of machine output comprises the final forecast). On average, CHML improves forecast accuracy compared to the ensemble ML methods by about 19.7% and judgmental adjustment by about 21.1%.

Applicants' findings contribute to theory in three main ways. First, Applicants introduce a novel process, CHML, to the literature on human-algorithm integration. The algorithm goes beyond previous work by systematically evaluating human judgment capabilities and algorithmic processing simultaneously. Though there is no a priori intention to assign primacy to the human or the machine, CHML facilitates an agency reversal. Rather than human learning from the machine, the machine learns from human input and systematically integrates machine and human input. Second, rather than designing behavioral and environmental interventions that improve human judgment, Applicants introduce a new economic institution, CHML. In doing so, Applicants demonstrate substantive improvements in overall process performance despite well-documented frailties in human judgment—namely, judgment bias and sequential effects in judgment. Lastly, Applicants derive five learning elements from prior literature and demonstrate how each is essential to creating a human-machine partnership.

### Example 3.2. Related Literature

Prior literature on behavioral economic theory provides a clear picture of how processes (i.e., institutions) are crucial to understanding how predictions and observations compare. Applicants preface Applicants' review by noting that behavioral economics recognizes the environment, the institution, and behavior. The environment refers to “the collection of all agents' characteristics . . . which in traditional economics are represented by utility or preference functions, resource endowments, and production or cost functions”. The institution is “the language (messages or actions) of communication . . . [that] specifies, either formally as on an organized exchange or informally by tradition, the order in which economics agents move”. Lastly, behavior “is concerned with agent choices of messages or actions given the agent's characteristics (environment) and the practices (institutional rules) relating such choices to allocations”. Applicants' focus is not on changing the environment or behavior but on changing the institution. In forecasting, the institution is the process through which the forecast is made. Most research on forecasting has focused on the environment and behavior, whereas Applicants highlight the institution's importance. In particular, Applicants posit that the institution plays a significant role in addressing the learning problem in a forecasting task.

The Learning Problem in Forecasting. A learning problem is defined as “the problem of a) improving some measure of performance when b) executing some tasks, through c) training some type of training experience”. The forecasting task is an example of a learning problem. In learning to predict demand, a) the measure of performance is forecast accuracy, b) the task is to estimate a quantity for demand that is as close as possible, ideally equal, to actual demand, and c) the training experience is often a database of historical demand. Researchers specify two data sources used in forecasting: public and private information. Public information is defined as “data that the algorithm uses”, typically the historical demand. Private information refers to information only a human has, or in other words, “any information with predictive value that the algorithm does not take into account”. Private information has also been referred to as contextual information. Training the algorithm in the machine learning literature has always referred to learning from public information. Recent research has introduced the idea of learning from human use of private information. Overall, prior literature from different streams has addressed the learning problem through the lens of purely automated machine forecasts, human judgment forecasts, and some mix of the two.

The forecasting learning problem through the lens of machine forecasts puts most of the focus on the (c) training experience, given that machines excel at synthesizing large quantities of data to identify systematic trends. The two types of machine forecasts most prevalent in the literature are statistical models and automated machine learning (AutoML) systems. The most common statistical models used in forecasting practice are naïve random walk models and exponential smoothing. However, most firms continue to use statistical models, and many plan to use or already use AutoML systems. Some of the AutoML algorithms that are being used, or planned on being used, are Bayesian Neural Networks, K-Nearest Neighbor Regression, Support Vector Regression, and Gaussian Processes. Prior research comparing the accuracy of statistical models and machine learning has found that simple statistical models are often more accurate than complex ML algorithms. However, despite the usefulness of machines in utilizing vast quantities of public information, they cannot still capture private information like human judgment can.

Another lens for addressing the forecasting learning problem is through judgmental forecasts. In contrast to machine forecasts, judgmental forecasts mainly focus on the task itself. While humans can recognize special events, humans need help with analyzing large quantities of data and quickly parsing through helpful and nonhelpful information. Therefore, although humans learn over time, the training experience often takes much longer, and the performance measure only sometimes translates into more accurate forecasts. A large body of literature documents biases identified in predictions made by human judgment. Given the high potential for complementarity between machines and human judgment, much of the forecasting literature has focused on integrating model-based forecasting systems and human judgment to take advantage of the strengths of each.

A third lens for addressing the forecasting learning problem is integrating machines and human judgment. While integrated methods are helpful in theory, in practice, they are compartmentalized in tackling the forecasting learning problem. For example, the most common integration method, judgmental adjustment, is where a human receives a machine forecast and adjusts that forecast. In this sequential process, a machine forecast observed by a human is followed by a human forecast. Furthermore, the training experience happens in isolation for the machine and the human—the machine is trained based on the database of public information, and the human is trained based on public and private information.

In summary, the three lenses used in prior literature for addressing the forecasting learning problem emphasize parts of the learning problem. In the following section, Applicants propose collaborative human-machine learning (CHML) to change the process by incorporating cohesively designed learning from experience into the institution or rules that govern the forecasting process.

### Example 3.3. Theory

The forecasting learning problem consists of a) improving a performance metric (i.e., forecast accuracy) and b) predicting demand through a c) training experience. To develop a collaborative process that utilizes machine and human learning, Applicants first studied prior theories and literature on behavioral operations, machine learning, and time series analysis to derive the elements crucial to forecasting. Applicants identified five elements: 1) the machine forecast, 2) human judgmental adjustments, 3) sequential effects in human judgment, 4) autocorrelated demand observations, and 5) a performance metric.

The first element, the machine forecast, refers to the output produced by the base system that processes available public information. As mentioned in the literature review, a machine could refer to statistical models, AutoML, or any algorithm that uses public information to produce a forecast. Applicants do not specify a specific algorithm for the machine forecast, but Applicants consider the machine forecast as an exogenous input into CHML. Prior literature offers significant evidence that machines can utilize large amounts of data to accurately predict time series, especially when the variability is systematic. Therefore, Applicants' first hypothesis is that using public information by the machine forecast is necessary for collaborative learning.
H1: The machine forecast using public information will significantly affect predictive performance.

The second element, human judgment, allows for incorporating private information. A large pool of prior literature suggests human judgment offers value through private information. However, given that humans are subject to bias, previous research has offered evidence that the precise means for including human judgment in forecasting can determine the usefulness of private information through judgment. Researchers find that the most accurate method of including private information through human judgment in the forecasting process is by human judgment to identify a particular event using private information. Using an algorithm that estimates the event's effect (human-guided learning) will be more accurate than using human judgment to estimate the effect of the special event. The reason is that an algorithm that weighs the effect based on the prior history of such estimates (integrated judgment learning) will correct for potential human bias. Following prior research, Applicants hypothesize that human judgment will have significant predictive power due to private information about special events not available to the algorithm:
H2: Human judgment using private information will have a significant effect on predictive performance.

Since human judgment uses private information to explain noise previously unexplained in machine forecasts by the base system, it is often useful to incorporate judgment into the process. However, including human judgment leads to two concerns: the sequential effects of human judgment and the potential violation of statistical assumptions. The following two hypotheses and the associated third and fourth elements address each concern separately.

Prior literature has suggested that sequential effects likely influence human judgment. The nature of these sequential effects must be clarified, as previous literature indicates there could be positive or negative autocorrelation in these judgments. As Applicants will explain, how humans use private information to forecast in the current period is likely influenced by private information from prior periods.

Previous literature from probability theory provides a valuable foundation when investigating potential autocorrelation in human judgment. Two common biases in sequential judgments are the gambler's fallacy and the hot hand. The gambler's fallacy is believing in the negative autocorrelation of a process's outcome. In other words, it is “the belief that the probability of an event is lowered when that event has recently occurred even though the probability of the event is objectively known to be independent of one trial to the next”. The hot hand believes in the positive autocorrelation of an individual's outcome. While both biases typically refer to sequential, independent events, there is evidence that the biases could also apply to sequential, dependent events.

Narrowing the focus to forecasting, researchers predict that significant judgmental adjustments to the current forecast will follow large errors from adjustments in the previous period. They summarized arguments for both positive and negative autocorrelation of errors and adjustments: Positive autocorrelation could occur due to increased risk-taking following significant losses or an overreaction to outcome feedback. On the other hand, negative autocorrelation could occur due to the gambler's fallacy, an unforeseen delay in an expected special event, or an aversion to modifying a previous act of commission. Researchers test their prediction using data from a large, multinational pharmaceutical company. They find evidence to support negative autocorrelation in adjustment direction due to errors in previous periods and a positive autocorrelation in error size.

Autocorrelation due to the interpretation of private information differs from the autocorrelation of adjustment errors. Positive autocorrelation could occur due to an overreaction to outcome feedback, especially if the time series is noisy. When a time series is noisy, it is possible to misinterpret higher (lower) sales as an increase (decrease) in demand when it could be due entirely to noise. This observation could influence the interpretation and use of private information in the following period. Positive autocorrelation could also occur due to hot hand either by placing more weight on gut feel and private information due to past accuracies (overconfidence) or by decreasing effort to identify private information due to complacency. Alternatively, negative autocorrelation could occur—the gambler's fallacy, an unforeseen delay in an expected special event, or an averseness to modify a previous act of commission.

In summary, Applicants argue there is a need to test and correct autocorrelation in human use of private information in judgment. Therefore, Applicants hypothesize that sequential effects in human judgment will significantly predict performance.
H3: Sequential effects in human judgment will have a significant effect on predictive performance.

It is necessary to address the second concern due to the inclusion of human judgment, which is the potential violation of independent and identically distributed (IID) data. Given that many ML/AI and statistical models meet IID assumptions, the machine forecast may or may not have ensured that the assumptions were met. In this research, Applicants assume the machine forecast is generated exogenously, and whether assumptions were met in the generation is unknown. However, there are two main reasons the assumptions need to be reassessed: 1) only some ML and statistical models assess IID assumptions, and 2) the introduction of human judgment helps explain error variance in the base system forecast and, therefore, potentially reintroduces autocorrelation in the data when controlling for the effects of human judgment.

ML and statistical models typically assume IID assumptions are met in the data but are not constantly tested. This is a concern since modern datasets are complex, interdependent, and have many different datasets exhibiting different distributions. Ensuring IID assumptions are met and addressed is crucial to provide accurate predictions. Accounting for IID assumptions by including lagged demand in the collaborative human-machine learning process ensures the assumptions are met, regardless of the machine forecast used.

The introduction of human judgment may reduce noise by explaining previously unlabeled noise, but it also may introduce noise, as human judgment is prone to many biases. Additionally, the private information used to inform judgment originates from many sources, all possibly interdependent with differing distributions. The violation of IID assumptions interferes with accuracy, reliability, and generalization of predictions. By including the lagged demand, the additional noise and interdependent sources of private information are accounted for, ensuring predictions are as accurate, reliable, and generalizable as possible.
H4: Sequential effects in demand will have a significant effect on predictive performance.

Finally, Applicants introduce a performance metric. Recall the forecasting learning problem definition: improving a performance metric by predicting demand through experience. In other words, the performance metric measures whether learning has occurred. A performance metric is a core element to increasing the predictive power of CHML, as it is to any learning system: 1) they incorporate quantified past and present learning into the experience, and 2) they improve training efficiency. First, by quantifying learning using a performance metric and then including the metric in CHML, not only is past learning incorporated for future predictions, but it also facilitates a continuous cycle of learning, which can account for changes in learning over time. Second, similar to what has been shown with humans, learning from previous algorithms can help improve efficiency during training. As such, performance metrics comparing prior machine forecasts and human judgment to demand in CHML enhance learning efficiency.

Another way to justify the inclusion of a performance metric can be found in a different domain—quality management. Continuous improvement and learning cycles are crucial parts of quality management that coincidentally follow foundational ideas that are the same as those used in human-machine learning. Namely, continuous improvement of a process is achieved through evaluating performance and applying learning from previous cycles to the next period. Similarly, in human-machine learning for forecasting, continuous improvement is attained through evaluating performance (i.e., performance metric) and applying past learning to future predictions (i.e., including the performance metric in CHML).

To summarize, combining the benefits found in machine learning literature with the reasoning of continuous improvement from quality management, including a performance metric in CHML, improves learning efficiency and expands experience, leading to increased accuracy. Formally, Applicants hypothesize:
H5: The performance metric will have a significant effect on predictive performance.

Applicants propose that the five elements found in literature build a collaborative human-machine learning process that is most advantageous in allowing the institution or process comprising public data, a base algorithm-based system, and humans with access to private information to learn. Prior literature suggests that bringing the five elements together is not trivial. The primary justification for CHML is that humans have access to private information that provides additional predictive power beyond the public information used by the machine forecast. Therefore, the crucial assumption is that humans have access to and can identify relevant private information. Given that this assumption is met, Applicants posit that CHML will be more accurate than the base machine forecast.

Prior literature suggests that there may be cases where CHML may not perform significantly differently than the base machine forecast. The four scenarios are 1) private information is unavailable, 2) private information is inaccurate or irrelevant, 3) judgment error follows a random distribution, and 4) sample size is too small to allow for learning. First, if private information is unavailable, deferring to the machine forecast is the first suggestion. However, if the CHML process is utilized and no judgment is provided, the CHML forecast will essentially become the machine forecast, lagged demand, and performance metric. Second, if private information is inaccurate or irrelevant, over time, CHML will detect that the judgment is not providing value and will weigh the judgment lower. CHML can remove individual bias and inaccurate private information from the forecast in these cases. Therefore, when private information is inaccurate or irrelevant, CHML will eventually limit the forecast to be comprised of the same elements as when there is no private information: machine forecast, lagged demand, and performance metric. In both cases, CHML should not damage the forecast accuracy but will likely not significantly differ from the machine forecast.

The third scenario, judgment error follows a random distribution, is more difficult for the model to correct. Since models are more proficient at detecting systematic errors, random errors can be interpreted as noise and interfere with forecast accuracy; however, including lagged judgments and lagged demand aids in controlling for non-systematic errors. As with the two prior scenarios, CHML should not damage the forecast accuracy but will likely not significantly differ from the machine forecast.

Lastly, a part of the forecasting learning problem is ensuring sufficient training experience. As such, CHML requires adequate data for training, and if there is not enough, predictive power decreases. Prior literature documents that as sample size increases, prediction improves. Therefore, Applicants predict a smaller sample size will lead to a less accurate CHML forecast; however, it should not damage the forecast accuracy but will likely not significantly differ from the machine forecast.

If relevant private information is available and humans can identify it, CHML will be more accurate than the machine forecast. In the four scenarios presented, Applicants predict CHML will not be less accurate than the machine forecast but may not be significantly different.
H6a: CHML will be more accurate than the machine forecast (base system).

Although judgmental adjustment is the most common method of integrating private information through human judgment into the forecast, prior literature has documented many pitfalls of leaving the final forecast in the hands of humans. Two of the most prominent issues with judgmental adjustment are 1) biases and 2) no internal feedback loop.

A large pool of literature details the biases most present in judgmental adjustments and even best practices to address the biases. While judgmental adjustment has long been the most used and studied, there still needs to be a definitive answer to managing biases. As such, by relying on judgmental adjustment to incorporate private information, the bias often outweighs the private information, leading to less accurate forecasts.

As documented in the literature review, the process of judgmental adjustment frequently separates the learnings from the machine forecast and the learnings from judgment into two silos resulting in two external feedback loops. The separation causes experience from the machine and humans to develop independently; often, judgment is not incorporated into the firm's training dataset for the machine.

The added biases and omitted learning caused by judgmental adjustment can lead to a decreased forecast accuracy compared to the machine forecast. Therefore, Applicants predict that using CHML, which not only ameliorates biases but also merges human-machine learning, will be more accurate than judgmental adjustment.
H6b: CHML will be more accurate than judgmental adjustment.

### Example 3.4. Empirical Setting and Data

To empirically test the hypotheses, Applicants partnered with a large multinational retailer that began implementing a sophisticated ensemble ML forecasting system to produce machine forecasts starting in February 2020. Despite shifting to a more complex ensemble ML forecasting system, the forecasting process remained the same as before judgmental adjustment (i.e., a human receives the machine forecast and can adjust before the final forecast).

Applicants' data contains information for ten product categories from February 2020 to August 2021. The dataset contains sales, machine forecasts, and adjustments at the SKU-store-week level. Before CHML generation, the dataset comprised 1,932,205 forecasts with 577,079 adjustments across 1,590 stores and 121 SKUs. Categories span consumables (supplements, foot care, baby) and groceries (spices).

Applicants generate CHML for each SKU-store i by training an algorithm on the first 20 weeks t of a particular SKU-store observation set, predicting CHML for the following week, and then updating the algorithm for each subsequent week. The generation of CHML follows three steps. First the CHML prediction is computed for each SKU-store i week t using machine forecast (MF_{i, t}), human judgment (HumanJudgment_{i, t}), sequential effects in judgment (HumanJudgment_{i, t-1}) and sequential effects in demand (Sales_{i, t-1}) resulting in CHML with no performance metric, or CHMLNP (Equation E3.1).

$$C H M L {1}_{i , t ,} = {β}_{0 , iT} + {β}_{1} M {F}_{i , t} + {β}_{2} {HumanJudgment}_{i , t} + {β}_{3} {HumanJudgment}_{i , t - 1} + {β}_{4} {Sales}_{i , t - 1} \qquad ( E3 \text{.1} )$$

$$where {HumanJudgment}_{i , t} = \{ \begin{matrix}0 if {ADJ}_{i , t} = 0 \\ 1 if {ADJ}_{i , t} \neq 0\end{matrix}$$

The performance metric (Performance_{i, t}) is then computed as the deviation between CHMLNP and Sales following Equation E3.2.

$${Performance}_{i , t} = C H M L N {P}_{i , t} - {Sales}_{i , t - 1} \qquad ( E3 \text{.2} )$$

Lastly, CHML is generated for each SKU-store i week t using machine forecast (MF_{i, t}), human judgment (HumanJudgment_{i, t}), sequential effects in judgment (HumanJudgment_{i, t-1}), sequential effects in demand (Sales_{i, t-1}), and the performance metric (Performance_{i, t}) as documented in Equation E3.3.

$$C H M {L}_{i , t ,} = {β}_{0 , iT} + {β}_{1} M {F}_{i , t} + {β}_{2} {HumanJudgment}_{i , t} + {β}_{3} {HumanJudgment}_{i , t - 1} + {β}_{4} {Sales}_{i , t - 1} + {β}_{5} {Performance}_{i , t} \qquad ( E3 \text{.3} )$$

The first 20 weeks of forecasts are dropped for training, so the final number of observations used in the main analysis is 1,311,005. Applicants analyze all observations aggregated to the SKU-store level to achieve independence. Additional analysis separated by category can be found in the Appendix.

### Example 3.5. Analysis and Results

Hypotheses 1-5 posit that each element, Machine Forecast, Human Judgment, Sequential Effects in Human Judgment, Sequential Effects in Demand, and the Performance Metric, will have predictive power. To empirically test these hypotheses, Applicants conducted a fixed effects regression analysis with standard errors clustered at the SKU-store-week level. Table 11 reports the results of this regression.

TABLE 11
Predictive Power of the Elements

| | Coefficient | SE | t | p-value |
|---|---|---|---|---|
| Machine Forecast | 0.412 | 0.028 | 14.700 | 0.000*** |
| Human Judgment | 1.436 | 0.058 | 24.740 | 0.000*** |
| Sequential Judgment | −0.296 | 0.070 | −4.260 | 0.000*** |
| Sequential Demand | 0.425 | 0.020 | 21.090 | 0.000*** |
| Performance Metric | −0.032 | 0.017 | −1.890 | 0.059* |

N = 1,311,005;
Groups = 31,060;
*p < 0.1,
** p < 0.05,
***p < 0.01

Overall, the elements are relatively significant predictors of demand. Machine Forecast, Human Judgment, Sequential Judgment, and Sequential Demand are all significant at the p<0.01 level. At this aggregate level, the Performance Metric is marginally significant at the p<0.1 level. As such, Applicants find support for Hypotheses 1-5.

Hypothesis 6a predicts that CHML will be more accurate than the machine forecast (MF). To test this hypothesis, Applicants use the Diebold-Mariano (1995) test to compare the accuracy of two forecasts. For simplicity, Applicants use Mean Absolute Percent Error (MAPE) for Applicants' initial accuracy comparison, as defined in Equation E3.4, given that all the data are positive and on the same scale (Hyndman & Koehler, 2006).

$$M A P E = \frac{1}{T} {\sum }_{t = 1}^{T} \vert \frac{( {Sales}_{i , t} - {Forecast}_{i , t} )}{( {Sales}_{i , t} + δ )} \vert \qquad ( E3 \text{.4} )$$

Where δ is 0.01 to ensure in cases where sales were zero, the MAPE would not be undefined.

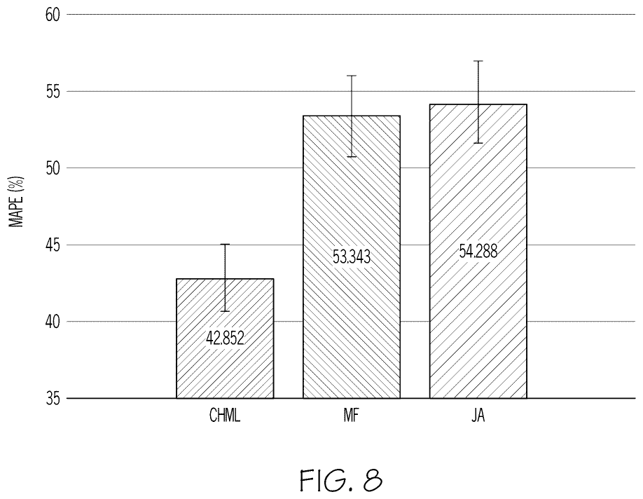

Note that the Diebold-Mariano test compares the difference between forecasts for every week t in the sample. Applicants report the results of the Diebold-Mariano tests comparing the MAPE for CHML and MF aggregated across the SKU-store level weighted by the number of observations in FIG. 8. The comparison of CHML (MAPE=42.852%) and MF (MAPE=53.343%) reveals that CHML is significantly more accurate than MF (DM Statistic=136.79, p-value=0.000). CHML increases accuracy over MF by 19.7%. These results support Hypothesis 6a.

Hypothesis 6b predicts that CHML will be more accurate than judgmental adjustment (JA). To test this hypothesis, follow the same analysis as Hypothesis 6a and report the results in FIG. 8. The comparison of CHML (MAPE=42.852%) and JA (MAPE=54.288%) reveals that CHML is significantly more accurate than the Judgmental Adjustment (DM Statistic=142.94, p-value=0.000). On average, CHML increases accuracy over JA by 21.1%. These results suggest that CHML is more accurate than JA regarding MAPE, supporting Hypothesis 6b.

### Example 3.6. Discussion

Applicants' research aims to reconceive the economic institution utilized in a demand planning process to facilitate the most accurate predictions from human-machine partnerships. To this end, Applicants designed a process, CHML, in which humans used their sensing capabilities and flexibility to bring private information into the process. In contrast, machine algorithms were used to process public information and to systematically integrate the two types of information in a human-machine learning system. Applicants' empirical testing using an extensive proprietary dataset from a retailer finds that each of the learning elements in CHML, including a machine forecast based on public information, human judgmental adjustments based on private information, and algorithmic integration of these two elements, accounting for sequential effects in human judgment, sequential effects in demand, and a performance metric was associated with increased forecast accuracy.

These findings contribute to the theory: First, Applicants introduce a novel process, CHML, to the literature on human-algorithm integration. The algorithm goes beyond previous work by systematically evaluating the capabilities of human judgment and algorithmic processing and designing a comprehensive process to take advantage of these complementary capabilities in a human-machine learning partnership. An important feature to be noted here is that there is an agency reversal. While there is no a priori intention to assign primacy to the human or the machine, there is a sharp contrast with extant practice. Rather than human learning from the machine, the machine learns from human input and systematically integrates machine and human input.

Second, Applicants contribute to the literature on behavioral operations management, particularly research on improving human forecasting performance. Rather than designing behavioral and environmental interventions that improve human judgment, Applicants introduce a new economic institution. Applicants address an important issue in conjunction with behavioral economics theory and forecasting by focusing on the institution. Prior literature on behavioral economic theory emphasizes that institutions are crucial to understanding how predictions and observations compare (Smith, 1989). The novel process CHML treats human judgmental accuracy as exogenous and redesigns the process to allow algorithmic efficiency to identify and correct systematic biases. In doing so, Applicants demonstrate substantive improvements in overall process performance despite well-documented frailties in human judgment—namely, judgment bias and sequential effects in judgment.

Third, Applicants contribute to the general literature on learning and machine-learning algorithms. Forecasting or prediction is an area that has received much attention in this literature. The novel algorithm CHML utilizes five elements of learning derived from literature. It combines them purposefully to design a process that treats human judgment and machine algorithms as important elements in a collaborative process.

Applicants' research substantially contributes to practice as CHML revolutionizes how the human-machine partnership can create value in the demand planning process. The most common current institution used by most organizations is judgmental adjustment. Applicants' findings reveal that judgmental adjustment does not adequately exploit the potential value afforded by the human-machine partnership. Applicants' findings reveal that using the combined category data from the field, Applicants can demonstrate a 19.7% improvement in forecast accuracy over the base machine learning system and a 21.1% improvement in forecast accuracy over judgmental adjustment. Such performance improvements can be genuinely transformational. Applicants' insights can also affect human productivity as CHML considerably simplifies the tasks humans need to perform. The focus on identifying special and anomalous events rather than trying to estimate quantities can reduce the time spent in the process and, therefore, free up time for other productive activities.

### Example 3.7. Future Research and Conclusion

Applicants' research has limitations. The first is that the dataset used field data, but Applicants did not conduct an experiment in the field. First, future research could build on Applicants' research by testing CHML in a field experiment, allowing for additional insights into the environment and behavior. Many issues can be learned in an active field setting, including the types of interventions that might enable more accurate detection and reporting of special events, strategic reporting of special events by demand planners who might seek to influence CHML forecasts, the effect of significant disruptions after which CHML may need to reset and re-estimate parameters. Although Applicants' dataset is large (˜1.9 million SKU-store-week observations), it includes only ten categories. Since it was beyond the scope of the current research to perform an in-depth analysis of category attributes, such as patterns of uncertainty that influence the efficacy of CHML, Applicants encourage future research to explore category differences and time series characteristics. Lastly, CHML is calculated without human interaction in this research. If humans are learning with the process, there could likely be even better performance. Applicants encourage future research to utilize a field experiment to test the live human-machine interaction.

In conclusion, despite the many advances in AI and ML systems, the partnership between humans and machines frequently fails to update the process, leaving value on the table. Applicants' findings reveal that a novel process, CHML, enables a partnership and human-machine learning system that improves performance above commonly used processes and technology alone. Applicants encourage future research to continue to test the boundaries of CHML and investigate applications beyond forecasting.

Without further elaboration, it is believed that one skilled in the art can, using the description herein, utilize the present disclosure to its fullest extent. The embodiments described herein are to be construed as illustrative and not as constraining the remainder of the disclosure in any way whatsoever. While the embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

1. A computer-implemented method for collaborative human-machine learning for demand planning, the method comprising:
receiving a forecast for the demand planning from a machine;
receiving an indication of a particular event using private information from a user;
estimating an effect of the particular event;
receiving lagged demand; and
adjusting the forecast for the demand planning using the estimated effect of the particular event and the lagged demand.

2. The method of claim 1, wherein the machine comprises at least one of a statistical model, a machine learning model, or an algorithm that uses public information to produce the forecast for the demand planning.

3. The method of claim 1, wherein the estimate of the effect of the particular event is based, at least in part, on weighing the particular event's effect based on a prior history of estimates of the particular event's effect.

4. The method of claim 1, comprising:
utilizing a performance metric to compare prior machine forecasts and human judgement to the adjusted forecast for the demand planning.

5. The method of claim 4, comprising:
continuing to adjust the forecast for the demand planning until the performance metric is improved to exceed a threshold value.

6. The method of claim 1, comprising:
receiving lagged judgements; and
adjusting the forecast for the demand planning using at least one of the estimated effect of the particular event, the lagged demand, and the lagged judgements.

7. The method of claim 1, wherein the private information corresponds to information with predictive value that an algorithm does not take into account.

8. A computer program product for collaborative human-machine learning for demand planning, the computer program product comprising one or more non-transitory computer readable storage mediums having program code embodied therewith, the program code comprising programming instructions for:
receiving a forecast for the demand planning from a machine;
receiving an indication of a particular event using private information from a user;
estimating an effect of the particular event;
receiving lagged demand; and
adjusting the forecast for the demand planning using the estimated effect of the particular event and the lagged demand.

9. The computer program product of claim 8, wherein the machine comprises at least one of a statistical model, a machine learning model, or an algorithm that uses public information to produce the forecast for the demand planning.

10. The computer program product of claim 8, wherein the estimate of the effect of the particular event is based, at least in part, on weighing the particular event's effect based on a prior history of estimates of the particular event's effect.

11. The computer program product of claim 8, wherein the program code comprises:
utilizing a performance metric to compare prior machine forecasts and human judgement to the adjusted forecast for the demand planning.

12. The computer program product of claim 11, wherein the program code comprises:
continuing to adjust the forecast for the demand planning until the performance metric is improved to exceed a threshold value.

13. The computer program product of claim 8, wherein the program code comprises:
receiving lagged judgements; and
adjusting the forecast for the demand planning using at least one of the estimated effect of the particular event, the lagged demand, and the lagged judgements.

14. The computer program product of claim 8, wherein the private information corresponds to information with predictive value that an algorithm does not take into account.

15. A system, comprising:
a memory for storing a computer program for collaborative human-machine learning for demand planning; and
a processor connected to the memory, wherein the processor is configured to execute program instructions of the computer program comprising:
receiving a forecast for the demand planning from a machine;
receiving an indication of a particular event using private information from a user;
estimating an effect of the particular event;
receiving lagged demand; and
adjusting the forecast for the demand planning using the estimated effect of the particular event and the lagged demand.

16. The system of claim 15, wherein the machine comprises at least one of a statistical model, a machine learning model, or an algorithm that uses public information to produce the forecast for the demand planning.

17. The system as recited in claim 15, wherein the estimate of the effect of the particular event is based, at least in part, on weighing the particular event's effect based on a prior history of estimates of the particular event's effect.

18. The system of claim 15, wherein the program instructions comprise:
utilizing a performance metric to compare prior machine forecasts and human judgement to the adjusted forecast for the demand planning.

19. The system of claim 18, wherein the program instructions comprise:
continuing to adjust the forecast for the demand planning until the performance metric is improved to exceed a threshold value.

20. The system of claim 15, wherein the program instructions comprise:
receiving lagged judgements; and
adjusting the forecast for the demand planning using at least one of the estimated effect of the particular event, the lagged demand, and the lagged judgements.
